(19) United States
(12) Patent Application Publication
(10) Pub. No.: US 2024/0422443 A1
(43) Pub. Date: Dec. 19, 2024

(54) IMAGING SYSTEM

(71) Applicant: Panasonic Intellectual Property Management Co., Ltd., Osaka (JP)

(72) Inventors: KEIKO YUGAWA, Nara (JP); MOTOKI YAKO, Osaka (JP)

(21) Appl. No.: 18/822,361

(22) Filed: Sep. 2, 2024

Related U.S. Application Data
(63) Continuation of application No. PCT/JP2023/007936, filed on Mar. 3, 2023.

(30) Foreign Application Priority Data
Mar. 17, 2022 (JP) 2022-042294
Feb. 14, 2023 (JP) 2023-021203

(51) Int. Cl. H04N 23/84; G01J 3/02; G01J 3/10; G01J 3/28

(52) U.S. Cl. CPC H04N 23/84; G01J 3/0297; G01J 3/10; G01J 3/2823; G01J 2003/102; G01J 2003/2843

(57) ABSTRACT

An imaging system includes a light source, an imaging apparatus that captures an image of a subject illuminated by light from the light source to generate image data, which includes image information regarding each of four or more bands or information regarding a compressed image in which the image information regarding the four or more bands is compressed as a single image, and a processing apparatus. The processing apparatus determines whether or not pixel values of pixels in the image data satisfy a predetermined condition, and causes, in a case where the predetermined condition is not satisfied, a lighting condition caused by the light source to be changed under a condition where a spectral shape of light from the light source does not change at the subject's location.

### BACKGROUND

### 1. Technical Field

The present disclosure relates to an imaging system.

### 2. Description of the Related Art

By utilizing spectral information regarding a large number of wavelength bands (hereinafter also simply referred to as “bands”) each of which has a narrow bandwidth, such as spectral information regarding a several tens of bands, it is possible to grasp the detailed properties of a target, which cannot be acquired using existing RGB images that have only information regarding three bands. Cameras that acquire images for many such wavelength bands are called “hyperspectral cameras”. Hyperspectral cameras are used in a variety of fields, including food inspection, biomedical examinations, pharmaceutical development, and mineral composition analysis.

International Publication No. 2015/199067 discloses an image analysis apparatus for analyzing the distribution of substances in the tissues of living organisms. The image analysis apparatus acquires sample images by irradiating the tissues of living organisms with light of N wavelength bands selected from a predetermined wavelength range to perform image capturing. By comparing the sample data based on the sample images with substance teacher data, distribution data of the substances in the tissues is generated. International Publication No. 2015/199067 discloses normalizing the intensity of light reflected by the surface of a sample on the basis of the intensity of light reflected by the surface of a reference material, such as a white panel.

U.S. Pat. No. 9,599,511 discloses an example of a hyperspectral imaging apparatus using compressed sensing. Compressed sensing is a technique that reconstructs more data than was observed, by assuming that the distribution of the data to be observed is sparse in a certain domain (for example, the frequency domain). The imaging apparatus disclosed in U.S. Pat. No. 9,599,511 includes an encoding element, which is an array of optical filters having different spectral transmittances from each other, along the optical path connecting a target and the image sensor. The imaging apparatus can generate images of wavelength bands through single imaging by performing reconstruction calculation based on a compressed image acquired through imaging using the encoding element.

### SUMMARY

In a hyperspectral imaging system that illuminates a subject with light from a light source to capture images, the light source may be adjusted to achieve preferable lighting conditions. Every time the light source is adjusted, spectral information regarding a calibration subject, such as a white panel, needs to be acquired.

One non-limiting and exemplary embodiment provides an imaging system and a method that make it possible to save labor in the image capturing process after light source adjustment.

In one general aspect, the techniques disclosed here feature an imaging system including a light source, an imaging apparatus that captures a subject illuminated by light from the light source to generate image data, and a processing apparatus. The image data includes image information regarding each of four or more bands or information regarding a compressed image in which the image information regarding the four or more bands is compressed as a single image. The processing apparatus determines whether or not pixel values of pixels in the image data satisfy a predetermined condition, and causes, in a case where the predetermined condition is not satisfied, a lighting condition caused by the light source to be changed under a condition where a spectral shape of light from the light source does not change at the subject's location.

It should be noted that general or specific embodiments may be implemented as a system, an apparatus, a method, an integrated circuit, a computer program, a computer readable recording medium, such as a recording disc, or any selective combination thereof. Examples of the computer readable recording medium include a nonvolatile recording medium such as a compact disc read-only memory (CD-ROM). The apparatus may be formed by one or more devices. In a case where the apparatus is formed by two or more devices, the two or more devices may be arranged in one apparatus or may be arranged in two or more separate apparatuses in a divided manner. In the present specification and the claims, an “apparatus” may refer not only to one apparatus but also to a system formed by apparatuses.

According to an aspect of the present disclosure, it is possible to save labor in the image capturing process after light source adjustment.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating the schematic configuration of an imaging system;

FIG. 2 is a flowchart illustrating an example of a processing method performed by a processing apparatus;

FIG. 3 is a diagram schematically illustrating an example of the configuration of an imaging system according to an exemplary embodiment of the present disclosure;

FIG. 4A is a flowchart illustrating an example of a hyperspectral image generation method;

FIG. 4B is a flowchart illustrating a modification of the method illustrated in FIG. 4A;

FIG. 5 is a flowchart illustrating an example of a specified range determination method;

FIG. 6A is a diagram illustrating an example of the data structure of a hyperspectral image;

FIG. 6B is a diagram illustrating another example of the data structure of a hyperspectral image;

FIG. 6C is a diagram illustrating yet another example of the data structure of a hyperspectral image;

FIG. 7 is a flowchart illustrating a modification of the method illustrated in FIG. 5;

FIG. 8 is a block diagram illustrating an example of the configuration of the imaging system;

FIG. 9 is a flowchart illustrating another example of the hyperspectral image generation method;

FIG. 10 is a flowchart illustrating another example of the specified range determination method;

FIG. 11 is a block diagram illustrating another example of the configuration of the imaging system;

FIG. 12A is a diagram schematically illustrating an example of the configuration of an imaging apparatus;

FIG. 12B is a diagram schematically illustrating another example of the configuration of the imaging apparatus;

FIG. 12C is a diagram schematically illustrating yet another example of the configuration of the imaging apparatus;

FIG. 12D is a diagram schematically illustrating yet another example of the configuration of the imaging apparatus;

FIG. 13A is a diagram schematically illustrating an example of a filter array;

FIG. 13B is a diagram illustrating an example of a spatial distribution of luminous transmittance of each of wavelength bands included in a target wavelength range;

FIG. 13C is a diagram illustrating an example of the spectral transmittance of a region A1 included in the filter array illustrated in FIG. 13A;

FIG. 13D is a diagram illustrating an example of the spectral transmittance of a region A2 included in the filter array illustrated in FIG. 13A;

FIG. 14A is a diagram for describing an example of the relationship between a target wavelength range and wavelength bands included in the target wavelength range;

FIG. 14B is a diagram for describing another example of the relationship between the target wavelength range and wavelength bands included in the target wavelength range;

FIG. 15A is a diagram for describing characteristics of the spectral transmittance of a certain region of the filter array; and

FIG. 15B is a diagram illustrating a result obtained by averaging spectral transmittances of each of the wavelength bands illustrated in FIG. 13A.

### DETAILED DESCRIPTIONS

In the present disclosure, all or some of circuits, units, devices, members, or portions or all or some of the functional blocks of a block diagram may be executed by, for example, one or more electronic circuits including a semiconductor device, a semiconductor integrated circuit (IC), or a large-scale integration circuit (LSI). The LSI or the IC may be integrated onto one chip or may be formed by combining chips. For example, functional blocks other than a storage device may be integrated onto one chip. In this case, the term LSI or IC is used; however, the term(s) to be used may change depending on the degree of integration, and the term system LSI, very large-scale integration circuit (VLSI), or ultra-large-scale integration circuit (ULSI) may be used. A field-programmable gate array (FPGA) or a reconfigurable logic device (RLD) that allows reconfiguration of interconnection inside the LSI or setup of a circuit section inside the LSI can also be used for the same purpose, the FPGA and the RLD being programmed after the LSIs are manufactured.

Furthermore, functions or operations of all or some of the circuits, the units, the devices, the members, or the portions can be executed through software processing. In this case, the software is recorded in one or more non-transitory recording media, such as a read-only memory (ROM), an optical disc, or a hard disk drive, and when the software is executed by a processing apparatus (a processor), the function specified by the software is executed by the processing apparatus and peripheral devices. The system or the apparatus may include the one or more non-transitory recording media in which the software is recorded, the processing apparatus, and a hardware device to be needed, such as an interface.

In this specification, data or a signal representing an image, that is, a group of data or signals representing the pixel value of each of pixels in the image may be simply referred to as an “image”.

### Underlying Knowledge Forming Basis of the Present Disclosure

In a hyperspectral imaging system with a light source, it is important to know what spectrum of light is emitted from the light source in order to acquire spectral information regarding the light reflected by the subject or transmitted through the subject. In addition, depending on the image capturing environment or the characteristics of the subject, the need to adjust the spectrum of light to be emitted may arise. For example, it may be necessary to adjust the light source to illuminate the subject at a luminance that does not cause pixel saturation of the image sensor (that is, at a luminance that is not too bright). In contrast, under too dark lighting conditions, noise becomes dominant compared to the original signal of the image sensor, and thus it is important to illuminate the subject at an appropriate luminance to obtain a favorable signal-to-noise ratio (S/N ratio). One method of adjusting luminance at the subject's location is to adjust control parameters, such as current or voltage for driving the light source. Alternatively, a method of adjusting the luminance at the subject's location by changing the orientation of the light source can be considered.

In a case where the luminance is adjusted using the method as described above, it is generally necessary to acquire information regarding the luminance distribution and spectrum of light at the subject's location for each adjustment. This is because changing the current, voltage or current and voltage for driving the light source or changing the orientation of the light source generally changes the luminance distribution at the subject's location. The operation described above may be performed by capturing an image of a calibration subject, such as a white panel for example, and acquiring information regarding the luminance distribution and spectrum thereof.

The present inventors have found that by changing the lighting conditions caused by the light source under conditions where the spectral shape of light at the subject's location does not change, it is possible to adjust luminance at the subject's location without performing an operation for capturing an image of a calibration subject such as a white panel again. The lighting conditions may be conditions regarding the amount of light emitted onto the subject being inspected or analyzed or onto a calibration subject, such as a white panel. The lighting conditions may be defined, for example, by parameters such as the distance between the light source and the subject, the current, voltage, or duty ratio of a pulse width modulation (PWM) signal for driving the light source, or the attenuation rate of a neutral density (ND) filter arranged between the light source and the subject. The present inventors have found that there are ranges of parameters in which the spectral shape of light at the subject's location does not change significantly and can be treated as nearly constant. For example, in a case where the distance between the light source and the subject is changed without changing the orientation of the light source, there is a distance range in which the spectral shape of light does not significantly change at the subject's location and can be treated as nearly constant. By identifying in advance a range of a parameter, such as distance, and adjusting the parameter within the range, it is possible to adjust luminance without performing the operation for capturing an image of a calibration subject, such as a white panel, again. Based on the above-described findings, the present inventors have arrived at the configurations of embodiments of the present disclosure as illustrated below.

In this case, a “spectral shape” means the shape of spectrum (namely, a wavelength distribution of light intensity) in which the intensity of each wavelength band is normalized by the intensity of a certain reference wavelength band. In contrast, the intensity of each wavelength band in a spectrum that is not normalized may be referred to as “spectral intensity”. The spectral shape is interpreted to be identical between a certain spectrum and a spectrum in which the intensity of each wavelength band in that spectrum is uniformly multiplied by a constant.

In the following, the summary of embodiments of the present disclosure will be described.

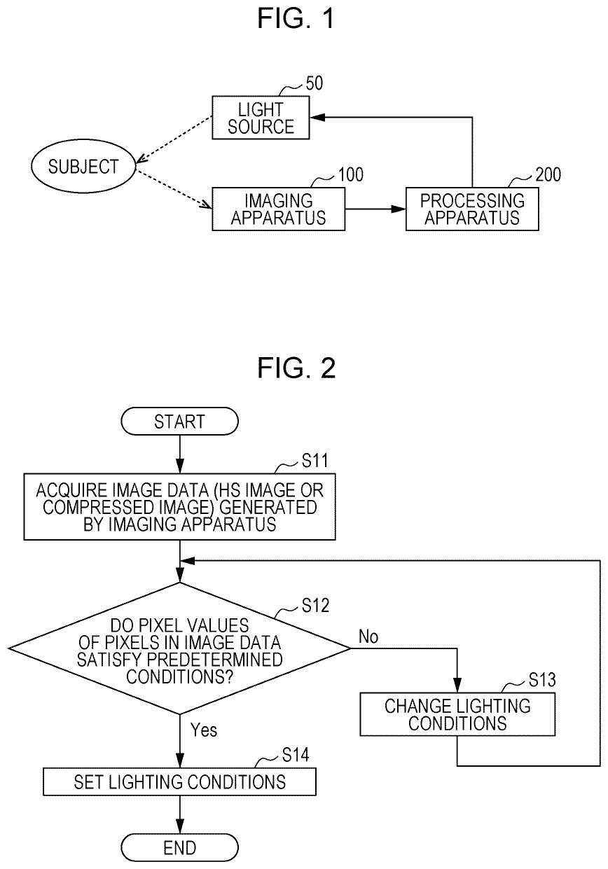

FIG. 1 is a block diagram illustrating the schematic configuration of an imaging system according to an embodiment of the present disclosure. The imaging system includes a light source 50, an imaging apparatus 100, and a processing apparatus 200. The imaging apparatus 100 captures an image of a subject illuminated by light from the light source 50 and generates image data. The image data includes image information regarding each of four or more bands or information regarding a compressed image in which the image information for each of the four or more bands is compressed as a single image. The processing apparatus 200 determines whether or not the pixel values of pixels in the image data satisfy predetermined conditions. In a case where the predetermined conditions are not satisfied, the processing apparatus 200 changes the lighting conditions caused by the light source 50, under conditions where the spectral shape of the light from the light source 50 does not change at the subject's location.

FIG. 2 is a flowchart illustrating an example of a processing method performed by the processing apparatus 200.

In Step S11, the processing apparatus 200 acquires image data generated by the imaging apparatus 100. The image data is data including image information regarding each of the four or more bands or data including information regarding a compressed image in which the image information regarding the four or more bands is compressed as a single image. Each of the four or more bands may be, for example, a relatively narrow wavelength range included in a preset target wavelength range. A target wavelength range W may be set to various ranges depending on applications. The target wavelength range W may be, for example, the visible light wavelength range from about 400 nm to about 700 nm, the near-infrared wavelength range from about 700 nm to about 2500 nm, or any other wavelength ranges. Each band may be a wavelength range having a predetermined width, such as 5 nm, 10 nm, 20 nm, or 50 nm, for example. The widths of the four or more bands may be identical to or different from each other. In the following description, image data including image information regarding each of the four or more bands may be referred to as a “hyperspectral image”. A hyperspectral image may include, for example, image information regarding 10 or more, 30 or more, or 50 or more bands. The image data including information regarding a compressed image may be generated through imaging using, for example, an optical element called an encoding element described in U.S. Pat. No. 9,599,511. In the following description, image data including information regarding a compressed image may be simply referred to as a “compressed image”. A compressed image is a monochrome image in which the image information regarding the four or more bands is compressed. As described below, the image of each band can be reconstructed by performing a reconstruction operation based on a compressed image and the data indicating the spatial distribution of the spectral transmittance of the encoding element.

In Step S12, the processing apparatus 200 determines whether or not the pixel values of pixels in the acquired image data satisfy predetermined conditions. In a case where the predetermined conditions are not satisfied, the process proceeds to Step S13. In a case where the predetermined conditions are satisfied, the process proceeds to Step S14. Examples of such conditions are described below.

In Step S13, the processing apparatus 200 changes the lighting conditions caused by the light source 50, under conditions where the spectral shape of light at the subject's location does not change. The processing apparatus 200 can change the lighting conditions by changing a parameter that defines the lighting conditions within a specified range in which the spectral shape the at the subject's location does not change. The parameter may be a parameter that defines, for example, the distance between the light source 50 and the subject, the current, voltage, or duty ratio of a PWM signal for driving the light source 50, or the attenuation rate of an ND filter arranged between the light source 50 and the subject. This makes it possible to change the luminance at the subject's location while maintaining the spectral shape.

After Step S13, the process returns to Step S12. The processing apparatus 200 changes the lighting conditions until the predetermined conditions become satisfied in Step S12. In a case where the predetermined conditions are satisfied, the process proceeds to Step S14, and the processing apparatus 200 sets the lighting conditions to the current conditions.

The expression “the spectral shape does not change” does not mean that the spectral shape does not change at all but means that the change in the spectral shape is within an acceptable range for the purpose or application. Assuming that the spectrum is a vector having N dimensions, where N is the number of bands and is an integer greater than or equal to 4, the change in the spectral shape may be evaluated on the basis of the angle or inner product between the vectors. For example, if the angle between two N-dimensional vectors representing two spectra is less than a reference value, it can be said that the spectral shapes of the two are identical. The reference value may be a relatively small value, such as 1°, 3°, 5°, or 10°, for example. Details of the method for evaluating the magnitude of the change in the spectral shape on the basis of the angle between vectors will be described later.

The imaging system may further include an adjustment apparatus that adjusts the distance between the light source 50 and the subject. In a case where the above-described predetermined conditions are not satisfied, the processing apparatus 200 may cause the adjustment apparatus to change the lighting conditions by changing the distance between the light source 50 and the subject within a specified range. In that case, the processing apparatus 200 determines the distance between the light source 50 and the subject to be a parameter that defines the lighting conditions.

In this case, the “specified range” is a parameter range in which the spectral shape of light from the light source 50 can be considered to be nearly constant at the subject's location. The specified range may be determined in advance through, for example, image capturing using a calibration subject, such as a white panel. The specified range may be stored in advance in the internal or external storage device of the processing apparatus 200. The processing apparatus 200 may be configured to change the lighting conditions by changing, within the specified range stored in the storage device, the parameter on the basis of the specified range. For example, in a case where the lighting conditions are changed by changing the distance between the light source 50 and the subject, the processing apparatus 200 controls the adjustment apparatus so as to change the distance within the specified range.

The above-described configuration makes it possible to adjust luminance while maintaining the spectral shape of illumination light at the subject's location. This can omit the operation for acquiring again spectral information regarding a calibration subject, such as a white panel, which is necessary after adjusting the luminance in the exiting technology. This allows the spectral information regarding the subject to be acquired more efficiently.

In the above-described configuration, the “predetermined conditions” may include, for example, a condition that the pixel value of each of pixels in image data (hereinafter simply also referred to as an “image”) generated by the imaging apparatus 100 is within a predetermined range. That is, determining whether or not the pixel values of the pixels satisfy the predetermined conditions may include determining whether or not the pixel value of each of the pixels is within the predetermined range. The predetermined range is, for example, a range where pixel saturation of the image sensor included in the imaging apparatus 100 does not occur (namely, not too bright) and where a favorable signal-to-noise (S/N) ratio is obtained (namely, not too dark) and may be set in advance. Note that the expression “the pixel value of each of the pixels is within the predetermined range” does not always mean that the pixel values of all the pixels in the image data are within the predetermined range. That is, the term “pixels” does not always mean all the pixels in the image data and may refer to some of the pixels. For example, a condition may be set that the pixel values of a preset percentage (such as 80%, 60%, or 40%) of the pixels are within the predetermined range.

The “predetermined conditions” may include, instead of or in addition to the above-described condition, a condition that a contrast value calculated from the pixel values of the pixels in the image data generated by the imaging apparatus 100 exceeds a threshold. That is, determining whether or not the pixel values of the pixels satisfy the above-described conditions may include determining whether or not the contrast value calculated from the pixel values of the pixels exceeds the threshold. The contrast value is, for example, an index value that represents the degree of spread of pixel values in the histogram of an image (that is, a graph representing the relationship between pixel value and pixel value frequency). The contrast value may be determined quantitatively using, as an index, the half width, the difference between the largest and smallest pixel values, the variance, or the standard deviation of the histogram of the image, for example. The contrast between the pixels included in the compressed image reflects the randomness in the encoding of each wavelength band at the time of imaging. Thus, the performance of encoding can be increased by increasing the contrast, so that the convergence of the solution in the reconstruction operation to be described later can be improved. Thus, in a case where whether or not the image data including information regarding the compressed image satisfies the predetermined conditions is to be determined, the reconstruction errors in the processing for reconstructing images of the respective bands from the compressed image can be reduced by imposing the condition that the contrast value exceeds the threshold value.

As illustrated in FIG. 2, the processing apparatus 200 may be configured to repeat, in a case where the predetermined conditions are not satisfied in Step S12, the operation for changing the parameter that defines the lighting conditions within the specified range until the above-described predetermined conditions become satisfied. With such a configuration, it is possible to automatically adjust the parameter, such as the distance between the light source 50 and the subject, such that the subject is illuminated with appropriate luminance. For example, the processing apparatus 200 may be configured to cause, in a case where the predetermined conditions are not satisfied, the adjustment apparatus to repeat the operation for changing the distance between the light source 50 and the subject within the specified range until the above-described predetermined conditions become satisfied.

The adjustment apparatus may be configured to change the distance between the light source 50 and the subject without changing the orientation of the light source 50. For example, the adjustment apparatus may include an actuator, such as a linear actuator, that translates the light source 50 in a direction away from or closer to the subject. With such a configuration, it is possible to adjust the distance between the light source 50 and the subject with the orientation of the light source 50 fixed. This facilitates adjustment of luminance while maintaining the spectral shape of light that illuminates the subject.

The processing apparatus 200 may adjust luminance at the subject's location by changing a control parameter for driving the light source 50 instead of by changing the distance between the light source 50 and the subject. That is, the processing apparatus 200 may be configured to change, in a case where the above-described predetermined conditions are not satisfied in Step S12, the lighting conditions by changing the control parameter for driving the light source 50 within a predetermined range. The control parameter for driving the light source 50 differs depending on the configuration of the light source 50. In a case where the light source 50 is, for example, a light-emitting diode (LED), the control parameter may be a current, voltage, or duty ratio of a PWM signal for driving the LED.

The imaging system may further include a mechanism for inserting one ND filter, which is selected from among ND filters, between the light source 50 and the subject. In a case where the above-described predetermined conditions are not satisfied, the processing apparatus 200 may change the lighting conditions by causing the above-described mechanism to switch the ND filter inserted between the light source 50 and the subject. One ND filter to be used is selected from among the ND filters with different light attenuation or transmittances. With such a configuration, it is possible to change luminance without changing the spectral shape at the subject's location by switching the ND filter.

The imaging apparatus 100 may be configured to generate image data including image information regarding each of the four or more bands. For example, the imaging apparatus 100 may be configured to spatially separate light by wavelength using a spectroscopic element such as a prism or grating to acquire an image of each band. Alternatively, the imaging apparatus 100 may have optical filters in front of the image sensor, each of which has a transmission wavelength range corresponding to one of the bands. The imaging apparatus 100 described above may be configured to generate images for each band on the basis of the intensity information regarding light transmitted through a corresponding one of the optical filters. The imaging apparatus 100 may include four or more image sensors corresponding to the four or more respective bands. In that case, each image sensor generates images for the corresponding band. The imaging apparatus 100 may be a hyperspectral camera that generates, for example, image data including image information regarding each of 10 or more or 100 or more bands.

The imaging apparatus 100 may be configured to generate image data including information regarding a compressed image in which the image information regarding each of the four or more bands is compressed as a single image. The imaging apparatus 100 described above may have substantially the same configuration as an imaging apparatus disclosed in, for example, U.S. Pat. No. 9,599,511. For example, the imaging apparatus 100 may include an optical element that changes the spatial distribution of the intensity of light from the subject by wavelength, and an image sensor that receives light passing through the optical element and generates image data including compressed image information. The optical element may be a filter array that includes, for example, optical filters arranged in a two-dimensional plane. The filter array may be designed such that the spectral transmittances of the optical filters are different from each other, and the spectral transmittances of the respective optical filters exhibit local maxima. Such a configuration makes it possible to generate a compressed image with which the image information regarding each of the four or more bands can be reconstructed by performing reconstruction processing based on compressed sensing.

In a case where the imaging apparatus 100 is configured to generate image data including information regarding a compressed image, the processing apparatus 200 may be configured to perform processing for generating images for the four or more respective bands on the basis of the compressed image. In that case, the processing apparatus 200 may be configured to generate images for the four or more respective bands on the basis of the compressed image, data indicating the spatial distribution of the spectral transmittance of the optical element, which is for example a filter array, and spectral data indicating the spatial distribution of the spectrum of illumination light acquired by capturing an image of a calibration subject (for example, a white panel) in advance.

In this manner, the processing apparatus 200 may generate other image data including the image information regarding each of the four or more bands on the basis of image data including information regarding a compressed image output from the image sensor. Moreover, the processing apparatus 200 may be configured to perform, in a case where the above-described predetermined conditions are satisfied, processing for generating images for the four or more respective bands on the basis of the compressed image, and not to perform the processing in a case where the above-described predetermined conditions are not satisfied. With such a configuration, images for the respective bands are generated in a case where the pixel values of the compressed image satisfy favorable conditions. Thus, high quality images for the four or more respective bands can be generated.

The processing for generating images for the four or more respective bands on the basis of a compressed image may be performed not only by the processing apparatus 200 but also by the processor of the imaging apparatus 100. In that case, the imaging apparatus 100 may include an optical element, such as the above-described filter array, an image sensor that receives light passing through the optical element, and a processor that generates, on the basis of the signal output from the image sensor, image data including image information regarding each of the four or more bands. In that case, first, the processor generates a compressed image on the basis of the signal output from the image sensor. Next, the processor may be configured to perform processing based on the compressed image and data reflecting the spatial distribution of the spectral transmittance of the optical element and the spatial distribution of the spectrum of light from the light source 50 to generate images for the four or more respective bands.

In a case where the imaging apparatus 100 generates image data including the image information regarding each of the four or more bands, the above-described predetermined conditions may include a condition that the pixel value of each of pixels in the image for each of the four or more bands is within a predetermined range. Instead of or in addition to this condition, the above-described predetermined conditions may include a condition that a contrast value calculated from the pixel values in the image for each of the four or more bands exceeds a threshold.

The imaging system may further include a storage device that stores data indicating a specified range for a parameter that defines the above-described lighting conditions. The specified range indicates a parameter range in which the spectral shape at the subject's location does not change. The processing apparatus 200 may be configured to change the lighting conditions by changing the above-described parameter within the specified range on the basis of data indicating the above-described specified range. For example, the processing apparatus 200 may be configured to cause the adjustment apparatus to change, on the basis of data indicating a specified range for the distance between the light source 50 and the subject, the distance between the light source 50 and the subject within the specified range.

The imaging system may further include a stage having a support surface that supports the subject. The adjustment apparatus may include a linear actuator that changes the distance between the light source 50 and the subject by moving the light source 50 in a direction perpendicular to the support surface of the stage.

The processing apparatus 200 may determine the specified range for the parameter on the basis of the relationship between calibration image data generated by the imaging apparatus 100 capturing images of a calibration subject illuminated by light from the light source 50 and the parameter that defines the lighting conditions.

The processing apparatus 200 may cause the imaging apparatus 100 to generate calibration image data while causing the adjustment apparatus to change the parameter that defines the lighting conditions, and determine, as a specified range, a parameter range in which the amount of change in the spectral shape of the calibration subject identified on the basis of the calibration image data is smaller than a predetermined amount.

The processing apparatus 200 may perform the following operations before capturing an image of the subject.
Acquire calibration image data generated by the imaging apparatus 100 capturing an image of the calibration subject illuminated by light from the light source 50.
Determine whether or not the pixel values of pixels in the calibration image data satisfy the above-described predetermined conditions.
Generate, in a case where the predetermined conditions are satisfied, spectral data of the calibration subject on the basis of the calibration image data and store the spectral data in the storage device.
Change, in a case where the predetermined conditions are not satisfied, the parameter that defines the lighting conditions within the specified range.

The above-described operations make it possible to acquire spectral data of the calibration subject (for example, a white panel) under favorable lighting conditions. The spectral data of the calibration subject is used in processing for generating images for the four or more respective bands on the basis of a compressed image.

In a case where the pixel values of pixels in the image data generated by the imaging apparatus 100 do not satisfy the predetermined conditions, the processing apparatus 200 may cause, instead of changing the lighting conditions caused by the light source 50, a display device or an audio output device to output a warning to prompt the user to change the lighting conditions. For example, the display device or the audio output device may be caused to output a warning to prompt changing of the distance between the light source 50 and the subject or the brightness of the light source 50 or switching of the ND filter inserted between the light source 50 and the subject. Such a function makes it possible to prompt the user to manually change the lighting conditions.

A processing method according to another embodiment of the present disclosure is performed by one or more processors that execute instructions recorded in one or more memories. The method includes acquiring image data from the imaging apparatus 100 that captures an image of the subject illuminated by light from the light source 50 to generate image data, the image data including image information regarding each of four or more bands or information regarding a compressed image in which the image information regarding the four or more bands is compressed as a single image, determining whether or not pixel values of pixels in the image data satisfy a predetermined condition, and changing, in a case where the predetermined condition is not satisfied, a lighting condition caused by the light source 50 under a condition where a spectral shape of light from the light source 50 does not change at the subject's location.

In the following, exemplary embodiments of the present disclosure will be described in more detail. Note that any one of the embodiments to be described below is intended to represent a general or specific example. Numerical values, shapes, constituent elements, arrangement positions and connection forms of the constituent elements, steps, and the order of steps indicated in the following embodiments are examples, and are not intended to limit the present disclosure. Among the constituent elements of the following embodiments, constituent elements that are not described in independent claims representing the most generic concept will be described as optional constituent elements. Each drawing is a schematic diagram and is not necessarily precisely illustrated. Furthermore, in each drawing, substantially the same or similar constituent elements are denoted by the same reference signs. Redundant description may be omitted or simplified.

### EMBODIMENTS

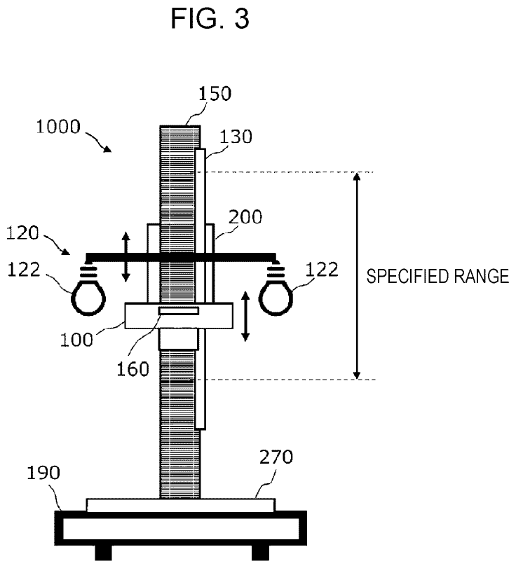

FIG. 3 is a diagram schematically illustrating an example of the configuration of an imaging system 1000 according to an exemplary embodiment of the present disclosure. The imaging system 1000 includes the imaging apparatus 100, a lighting device 120, the adjustment apparatus 130, the processing apparatus 200, a stage 190, and a supporting member 150. The stage 190 has a flat support surface (the top surface in this example), and a subject 270 is arranged on the support surface. The supporting member 150 is fixed to the stage 190 and has a structure that extends in a direction perpendicular to the support surface of the stage 190. The supporting member 150 supports the imaging apparatus 100, the lighting device 120, and the adjustment apparatus 130. The imaging apparatus 100 includes an image sensor 160. The lighting device 120 has two light sources 122. The number of light sources 122 is not limited to two and may be one or three or more. The adjustment apparatus 130 has a mechanism for adjusting the distance between the light sources 122 and the subject 270. The processing apparatus 200 is a computer having one or more processors and one or more memories. The processing apparatus 200 controls the adjustment apparatus 130 on the basis of image data output from the imaging apparatus 100.

The adjustment apparatus 130 in the example illustrated in FIG. 3 has a mechanism for moving each of the lighting device 120 and the imaging apparatus 100 in a direction perpendicular to the support surface of the stage 190 (hereinafter also referred to as a “height direction”). The adjustment apparatus 130 may include an actuator (for example, a linear actuator) including one or more motors. The actuator may be configured to change the distance between the light sources 122 and the subject 270 using, for example, an electric motor, hydraulic pressure, or pneumatic pressure. In the example illustrated in FIG. 3, the adjustment apparatus 130 can change not only the position of the lighting device 120 but also that of the imaging apparatus 100. The adjustment apparatus 130 does not necessarily have a mechanism for changing the position of the imaging apparatus 100. The adjustment apparatus 130 also has a measurement device that measures the distance between the stage 190 and the light sources 122.

The supporting member 150 in the example illustrated in FIG. 3 has marks indicating heights from the support surface of the stage 190. Based on the marks, the position of the imaging apparatus 100 and that of the light sources 122 in the height direction can be known.

The imaging apparatus 100 may be, for example, a camera that generates image data including information regarding images for the four or more respective bands. The imaging apparatus 100 may be configured to generate, for example, a hyperspectral image including information regarding images for 10 or more respective bands. Alternatively, the imaging apparatus 100 may be a camera that generates image data including information regarding a compressed image in which information regarding images for each of the four or more respective bands is compressed as a single image, as disclosed in U.S. Pat. No. 9,599,511. By performing reconstruction processing based on compressed sensing, the image data of each of the four or more bands can be reconstructed from the data of the compressed image. A specific example of reconstruction processing based on compressed sensing will be described later. The imaging apparatus 100 captures an image of the subject 270 illuminated by light from the light sources 122 to generate image data including image information regarding each of the four or more bands or information regarding a compressed image in which the image information regarding the four or more bands is compressed as a single image. The imaging apparatus 100 may acquire still or moving images. A specific example of the configuration of the imaging apparatus 100 will be described later.

The lighting device 120 is a device that has at least one light source 122 and illuminates the subject 270 on the stage 190. Light emitted from the light sources 122 may be, for example, visible light, infrared rays, or ultraviolet rays. Note that, in this specification, not only visible light but also electromagnetic waves including infrared and ultraviolet rays are referred to as “light”. In the example illustrated in FIG. 3, the two light sources 122 are arranged on both sides of the imaging apparatus 100; however, the number of and arrangement of light sources 122 are not limited to those in this example and can be changed as appropriate.

The processing apparatus 200 has the function of a controller that controls the light sources 122, the imaging apparatus 100, and the adjustment apparatus 130. The processing apparatus 200 instructs the light sources 122 to turn on and the imaging apparatus 100 to capture images. The processing apparatus 200 further causes the adjustment apparatus 130 to adjust the distance between the light sources 122 and the subject 270 on the basis of the image data of the subject 270 output from the imaging apparatus 100. Specifically, first, the processing apparatus 200 determines whether or not the pixel values of pixels in the image data satisfy predetermined conditions. In a case where the conditions are not satisfied, the processing apparatus 200 causes the adjustment apparatus 130 to change, within a specified range, the distance between the light sources 122 and the subject 270. For example, in a case where the conditions are not satisfied, the processing apparatus 200 repeats an operation for causing the adjustment apparatus 130 to change the distance between the light sources 122 and the subject 270 by a predetermined distance within the specified range until the above-described conditions become satisfied. In this manner, in the present embodiment, the processing apparatus 200 changes the distance between the light sources 122 and the subject 270 to change the lighting conditions caused by the light sources 122.

The specified range is determined on the basis of calibration image data acquired by the imaging apparatus 100 capturing an image of the calibration subject, an example of which is a white panel. For example, the processing apparatus 200 determines the specified range on the basis of the relationship between the calibration image data and the distance between the light sources 122 and the calibration subject. Specifically, the processing apparatus 200 causes the imaging apparatus 100 to generate calibration image data while causing the adjustment apparatus 130 to change the distance between the light sources 122 and the calibration subject. The processing apparatus 200 determines, for example, a distance range in which the spectral shape of the calibration subject identified on the basis of the calibration image data can be regarded as constant to be the specified range. Alternatively, the processing apparatus 200 may determine a distance range in which the spectral shape of the calibration subject can be regarded as constant and the luminance falls within a predetermined range to be the specified range. The processing apparatus 200 stores the determined specified range in, for example, a storage device such as a memory inside the processing apparatus 200.

### Light Source Position Adjustment

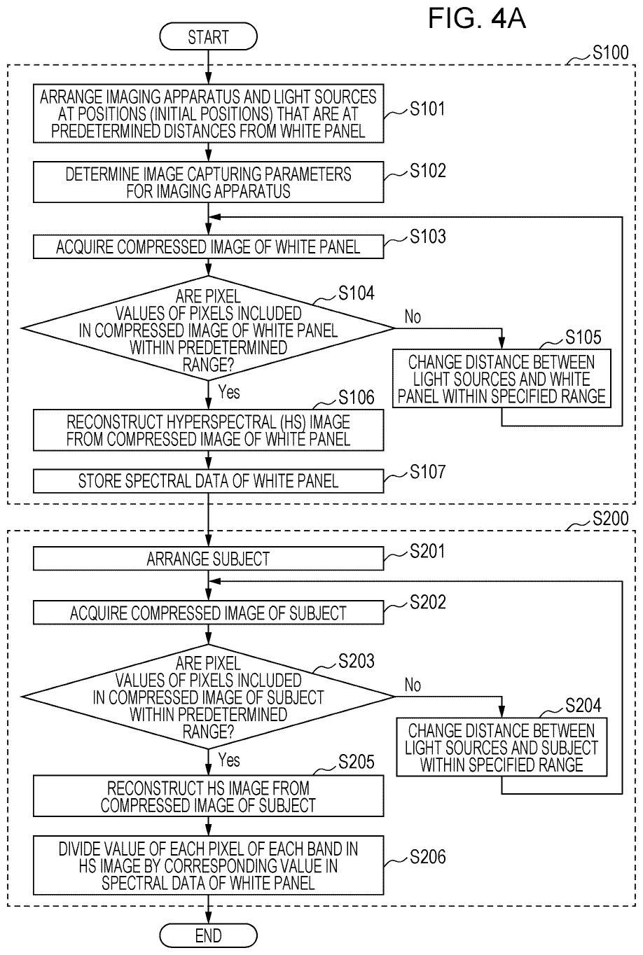

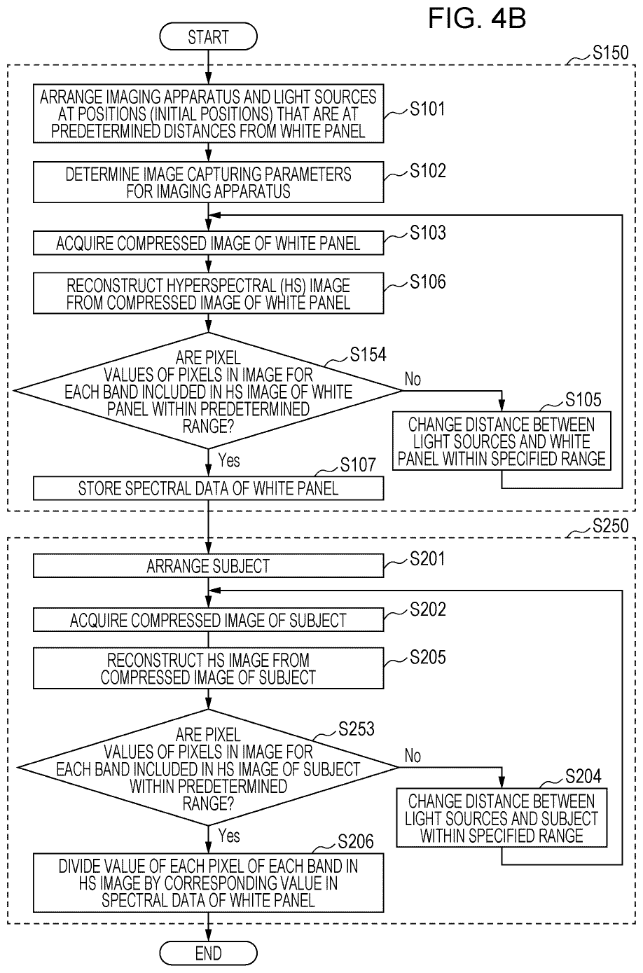

FIG. 4A is a flowchart illustrating an example of a hyperspectral image generation method using the imaging system 1000 according to the present embodiment. In the example illustrated in FIG. 4A, the imaging apparatus 100 generates a compressed image in which image information for bands (for example, 10 to 100 bands or more) constituting a hyperspectral image is compressed as a single image. As disclosed in U.S. Pat. No. 9,599,511, the imaging apparatus 100 performs image capturing through a filter array including optical filters to generate a compressed image. The optical filters have individual spectral transmittances, and the spectral transmittances of the respective optical filters exhibit local maxima at wavelengths. Spectral transmittance represents the wavelength dependency of transmittance and is also referred to as transmission spectrum. The processing apparatus 200 reconstructs a hyperspectral image on the basis of the generated compressed image, the data of the spectral transmittances of the respective filters of the filter array, and the data of the spectrum of light from the light sources 122 at the subject's location. In the example illustrated in FIG. 4A, the spectral data of light from the light sources 122 at the subject's location is acquired by capturing an image of a white panel, which is the calibration subject.

The method illustrated in FIG. 4A includes Step S100 for acquiring the spectral data of the white panel, which is the calibration subject, and Step S200 for generating a hyperspectral image of a subject using the spectral data of the white panel. Step S100 includes Steps S101 to S107. Step S200 includes Steps S201 to S206.

In Step S101, the imaging apparatus 100 and light sources 122 are arranged at initial positions that are at predetermined distances from the white panel arranged on the stage 190. The imaging apparatus 100 and light sources 122 may be arranged at the initial positions by the adjustment apparatus 130 under control performed by the processing apparatus 200. Alternatively, the user may manually arrange the imaging apparatus 100 and light sources 122 at the initial positions.

In Step S102, image capturing parameters for the imaging apparatus 100 are determined. Specifically, parameters such as exposure time and gain that affect the luminance of an image to be acquired are determined. These parameters may be, for example, set in accordance with an input from the user or automatically set to appropriate values.

In Step S103, the imaging apparatus 100 captures an image of the white panel arranged on the stage 190 to acquire a compressed image. Image capturing may be performed, for example, in accordance with an operation performed by the user or in accordance with an instruction from the processing apparatus 200.

In Step S104, the processing apparatus 200 determines whether or not the pixel values of respective pixels included in the acquired compressed image are within a predetermined range. The predetermined range is a range in which a favorable hyperspectral image can be reconstructed on the basis of a compressed image and is recorded in advance in a memory of the processing apparatus 200, for example. The upper limit of the predetermined range may be determined, for example, on the basis of the upper limit of the amount of light received that can be distinguished by the light detection element of the image sensor. When the amount of light received exceeds the upper limit, the pixel values become constant, and the difference between pixel values greater than or equal to the upper limit cannot be detected. In that case, it becomes difficult to obtain an accurate reconstructed image for the portions of pixel values greater than or equal to the upper limit. In contrast, the lower limit of the predetermined range is the lower limit of pixel values at which the reconstruction operation can yield a reconstructed image with low levels of error. The lower the pixel value, the greater the relative effect of noise, and thus it becomes difficult to obtain an accurate reconstructed image using the reconstruction operation. By setting the lower limit, it can be ensured that the error in the reconstruction operation derived from noise is less than or equal to a certain level. The upper limit of the predetermined range may be set, for example, to a value close to 100% of the maximum pixel value, and the lower limit may be set, for example, to a value greater than or equal to 20% to 50% of the maximum pixel value. Setting such a range can increase the width of the luminance range and makes it easier to distinguish differences in luminance. The processing apparatus 200 may determine whether or not the pixel values of all pixels included in the compressed image are within the predetermined range. Alternatively, the processing apparatus 200 may determine whether or not the pixel values of a predetermined percentage (for example, 80%, 70%, or 60%) of the pixels included in the compressed image are within the predetermined range. By making a such a determination, it is possible to avoid a situation where the processing does not proceed in a case where the pixel values of a few pixels in the compressed image are out of the predetermined range.

In a case where a determination of No is obtained in Step S104, the process proceeds to Step S105. In a case where a determination of Yes is obtained in Step S104, the process proceeds to Step S106.

In Step S105, the processing apparatus 200 causes the adjustment apparatus 130 to change the distance between the light sources 122 and the white panel within a specified range without changing the orientations of the light sources 122 (namely, their angles). For example, the processing apparatus 200 causes the adjustment apparatus 130 to change the position of the light sources 122 upward or downward in the height direction by a preset unit length. Thereafter, the process returns to Step S103, and the imaging apparatus 100 acquires a compressed image of the white panel again. The operations in Steps S103 to S105 are repeated until a determination of Yes is obtained in Step S104. Note that as a result of the light sources 122 moving from the initial position upward or downward in units of the unit length, the distance between the light sources 122 and the white panel may reach the upper or lower limit of the specified range without a determination of Yes being made in Step S104. In that case, the processing apparatus 200 may return the light sources 122 to their initial position and perform substantially the same operation while moving the light sources 122 in the opposite direction in units of the unit length. In a case where a determination of Yes is not made in Step S104 at any position in the specified range, the processing apparatus 200 may stop the operation of the adjustment apparatus 130 and output a warning to an external device such as a display.

In the example illustrated in FIG. 4A, the processing apparatus 200 changes the height of the light sources 122 within the specified range but may move the light sources 122 beyond the specified range in a case where a determination of Yes is not obtained in Step S104 even when the height reaches the upper or lower limit of the specified range. The processing apparatus 200 may output a warning including information indicating the position of the light sources 122 in a case where a determination of Yes is made in Step S104 when the light sources 122 are at a position outside the specified range.

In a case where it is determined in Step S104 that the pixel values of pixels included in the compressed image of the white panel are within the predetermined range, the process proceeds to Step S106. In Step S106, the processing apparatus 200 reconstructs a hyperspectral image from the compressed image of the white panel. Details of the reconstruction processing will be described later. This allows the spectral data of the white panel to be obtained. The spectral data of the white panel may be data indicating the reflected light intensity of each pixel in the image of each of the bands.

Subsequently, in Step S107, the processing apparatus 200 causes the storage device to store the spectral data of the white panel. The storage device may be, for example, any storage device, such as a memory inside the processing apparatus 200 or an external storage of the processing apparatus 200.

By performing Steps S101 to S107 described above, the spectral data of the white panel can be acquired. The spectral data of the white panel is used to eliminate the effect of background light in subsequent operations to acquire a hyperspectral image of the subject. Note that the white panel is used as a calibration subject in the present embodiment, but other calibration subjects may also be used.

In the present embodiment, the distance between the light sources 122 and the subject is adjusted within the specified range narrower than the range in which the adjustment apparatus 130 can move the light sources 122. As the specified range, a range in which the spectral shape of light at the subject's location does not change significantly is determined in advance. Assuming that the spectrum is a vector with N dimensions, where N is the number of divisions of the wavelength band, changes in spectral shape may be evaluated on the basis of the angle or inner product between vectors. For example, in a case where the angle between two N-dimensional vectors representing the spectrum is less than a threshold, the vectors can be processed as having the same spectral shape. A specific example of a method for determining the specified range will be described later. As long as the distance between the light sources 122 and the subject is changed within the specified range in which the spectral shape does not change significantly, the spectral data stored in Step S107 can be used in a shared manner without any change. That is, in a case where the distance between the light sources and the subject is changed within the specified range, the spectral data of the white panel does not need to be acquired again. In contrast, in existing methods, it is necessary to acquire the spectral data of the white panel again in a case where the distance between the light sources and the subject is changed. In the present embodiment, the specified range in which the spectral shape does not change significantly is predetermined, and an operation for acquiring the spectral data of the white panel (or another calibration subject) again can be omitted by changing the distance within the range. This makes it possible to efficiently acquire a hyperspectral image of the subject.

Subsequently, the operation for acquiring a hyperspectral (HS) image of the subject in Step S200 will be described. Once the spectral data of the white panel is acquired, an operation for acquiring a hyperspectral image of the subject to be inspected can be performed. In Step S200, the luminance of the subject is adjusted. This is because subjects have unique colors and reflectance spectra that vary from subject to subject, and thus even in a case where the luminance is appropriate for the white panel, it may be too dark for the subject.

First, in Step S201, the subject to be inspected is arranged on the stage 190. In a case where the white panel is arranged on the stage 190, the subject is arranged after removing the white panel.

In Step S202, the imaging apparatus 100 captures an image of the subject to acquire a compressed image. Image capturing is performed, for example, in accordance with an operation performed by the user or in accordance with an instruction from the processing apparatus 200.

In Step S203, the processing apparatus 200 determines whether or not the pixel values of pixels included in the acquired compressed image are within a predetermined range. This processing is substantially the same as the processing in Step S104. As described above, the predetermined range is preset as a range in which a favorable hyperspectral image can be reconstructed on the basis of a compressed image. Similarly to as in Step S104, the processing apparatus 200 may determine whether or not the pixel values of not all the pixels but a predetermined percentage (for example, 80%, 70%, or 60%) of the pixels included in the compressed image are within the predetermined range.

In a case where a determination of No is obtained in Step S203, the process proceeds to Step S204. In a case where a determination of Yes is obtained in Step S203, the adjustment of luminance is completed, and then the process proceeds to Step S205.

In Step S204, the processing apparatus 200 causes the adjustment apparatus 130 to change the distance between the light sources 122 and the subject within the specified range. This operation is substantially the same as that in Step S105. For example, the processing apparatus 200 causes the adjustment apparatus 130 to change the position of the light sources 122 upward or downward in the height direction by a preset unit length. Thereafter, the process returns to Step S202, and the imaging apparatus 100 acquires a compressed image of the subject again. The operations in Steps S202 to S204 are repeated until a determination of Yes is obtained in Step S203. Note that as a result of the light sources 122 moving from the initial position upward or downward in units of the unit length, the upper or lower limit of the specified range may be reached. In that case, the processing apparatus 200 may return the light sources 122 to their initial position and perform substantially the same operation while moving the light sources 122 in the opposite direction in units of the unit length. In a case where a determination of Yes is not made in Step S203 at any position in the specified range, the processing apparatus 200 may stop the operation of the adjustment apparatus 130 and output a warning to an external device such as a display. The warning may include a message recommending that the operation for acquiring the spectral data of the white panel in Step S100 be performed again.

In a case where a determination of Yes is not made in Step S203 within the specified range, the processing apparatus 200 may make an adjustment by changing the control parameter, such as the current or voltage for driving the light sources 122, within a range in which the spectral shape does not change, so that a determination of Yes is obtained in Step S203.

In a case where it is determined in Step S203 that the pixel values of pixels included in the compressed image of the subject are within the predetermined range, the process proceeds to Step S205. In Step S205, the processing apparatus 200 reconstructs a hyperspectral image from the compressed image of the subject. This processing is substantially the same as that in Step S106, and details of the reconstruction processing will be described later.

Subsequently, in Step S206, the processing apparatus 200 reads out, from the storage device, the spectral data of the white panel stored in Step S107, and the value of each pixel of each band of the hyperspectral image reconstructed in Step S205 is divided by a corresponding value in the spectral data of the white panel. This results in a hyperspectral image in which the effect of the luminance distribution of light from the light sources 122 is removed. The processing apparatus 200 causes the storage device to store this hyperspectral image. The processing apparatus 200 may cause the display to display this hyperspectral image.

Through the above-described operation, a hyperspectral image of the subject can be efficiently acquired. According to existing methods, it is necessary to acquire the spectral data of the white panel every time the power of light emitted from the light sources 122 or the orientations or positions of the light sources 122 are changed to adjust the luminance at the subject's location. In other words, in the existing methods, it is necessary to repeat acquisition of the spectral data of the white panel and acquisition of the spectral data of the subject in an alternating manner. Such an operation is very troublesome, and improvement has been desired. For example, the subject and the white panel are usually different in thickness, and thus adjustment is needed to cancel the thickness difference between the subject and the white panel every time the subject and the white panel are changed in order to equalize the distances from the light sources. In contrast, in the present embodiment, in a case where a determination of No is obtained in Step S203, the distance between the light sources and the subject is changed within the specified range in which the spectral shape does not change, so that the operation for acquiring the spectral data of the white panel again can be omitted. This makes it possible to acquire a hyperspectral image of the subject more efficiently than in the existing methods.

After Step S206, a hyperspectral image of the subject can be acquired in a continuous manner without acquiring the spectral data of the white panel again. For example, a hyperspectral moving image can also be generated by continuously performing image capturing.

In the example illustrated in FIG. 4A, after the spectral data of the white panel is acquired through the operations included in Step S100, a hyperspectral image of the subject is generated by performing the operations included in Step S200. However, the order of these steps may be switched. That is, the operations included in Step S200 other than Step S206 may be performed first, and thereafter the spectral data of the white panel may be acquired by performing the operations included in Step S100 to generate a hyperspectral image of the subject. Then, each pixel value of the image of each band in the hyperspectral image may be divided by a corresponding value in the spectral data of the white panel to generate a final hyperspectral image. Even in that case, the distance between the light sources and the subject and the distance between the light sources and the white panel are changed within the specified range in which the spectral shape does not change at the subject's location.

In the example illustrated in FIG. 4A, whether or not the amount of light at the location of the white panel or the subject's location is appropriate is evaluated on the basis of the compressed image; however, this evaluation may be made on the basis of the hyperspectral image. In the following, an example of such a method will be described.

FIG. 4B is a flowchart illustrating a modification of the method illustrated in FIG. 4A. In the example illustrated in FIG. 4B, whether or not the amount of light is appropriate is evaluated on the basis of not a compressed image but a hyperspectral image.

The method illustrated in FIG. 4B includes Step S150 for acquiring the spectral data of the white panel and Step S250 for acquiring a hyperspectral image of the subject. The differences between Step S150 and Step S100 included in FIG. 4A are that Step S106 is performed immediately after Step S103, and Step S154 is performed instead of Step S104 and immediately after Step S106. Moreover, the differences between Step S250 and Step S200 illustrated in FIG. 4A are that Step S205 is performed immediately after Step S202, and Step S253 is performed instead of Step S203 and immediately after Step S205. In the following, points different from those in the example illustrated in FIG. 4A will be mainly described.

The operations in Steps S101 to S103 in the example illustrated in FIG. 4B are the same as those in the example illustrated in FIG. 4A. After Step S103, the process proceeds to Step S106, and the processing apparatus 200 reconstructs a hyperspectral image from the compressed image of the white panel. The reconstruction method is the same as that in the example illustrated in FIG. 4A, and details will be described later.

Subsequently, in Step S154, the processing apparatus 200 determines whether or not the pixel value of each of pixels included in the hyperspectral image of the white panel is within a predetermined range. This processing may be performed on each of the images of the bands constituting the hyperspectral image. That is, in a case where the hyperspectral image includes a first image corresponding to a first band and a second image corresponding to a second band, it may be determined whether or not the pixel value of each of pixels included in the first image is within the predetermined range and whether or not the pixel value of each of pixels included in the second image is within the predetermined range. The predetermined range may be different for each band, namely for each wavelength range. The processing apparatus 200 may determine whether or not the pixel value of each of all the pixels included in the image of each band included in the hyperspectral image of the white panel is within the predetermined range. Alternatively, the processing apparatus 200 may determine whether or not the pixel values of a predetermined percentage (for example, 80%, 70%, or 60%) of the pixels of the image of each band included in the hyperspectral image are within the predetermined range. Moreover, the processing apparatus 200 may determine whether or not the pixel values of some or all of the pixels of not all the bands but some of the bands included in the hyperspectral image are within the predetermined range.

In a case where a determination of No is obtained in Step S154, the process proceeds to Step S105, and the distance between the light sources 122 and the white panel is changed within the specified range. Thereafter, the process returns to Step S103, and a compressed image of the white panel is acquired again. The operations in Steps S103, S106, S154, and S105 are repeated until a determination of Yes is obtained in Step S154.

In a case where a determination of Yes is obtained in Step S154, the process proceeds to Step S107, and the processing apparatus 200 causes the storage device to store the spectral data of the white panel.

After Step S107, a hyperspectral image of the subject can be acquired in Step S250.

The operations in Steps S201 and S202 are the same as those in the example illustrated in FIG. 4A. After Step S202, the process proceeds to Step S205, and the processing apparatus 200 reconstructs a hyperspectral image from the compressed image of the subject.

Subsequently, in Step S253, the processing apparatus 200 determines whether or not the pixel value of each of pixels included in the hyperspectral image of the subject is within a predetermined range. This processing may be performed on each of the images of the bands constituting the hyperspectral image. The predetermined range may be different for each band, namely for each wavelength range. This processing is substantially the same as the processing in Step S154. Similarly to as in Step S154, the processing apparatus 200 may determine whether or not the pixel values of not all the pixels but a predetermined percentage (for example, 80%, 70%, or 60%) of the pixels of the image of each band included in the hyperspectral image are within the predetermined range. Moreover, the processing apparatus 200 may determine whether or not the pixel values of some or all of the pixels of not all the bands but some of the bands included in the hyperspectral image are within the predetermined range.

In a case where a determination of No is obtained in Step S253, the process proceeds to Step S204, and the distance between the light sources 122 and the subject is changed within the specified range. Thereafter, the process returns to Step S202, and a compressed image of the subject is acquired again. The operations in Steps S202, S205, S253, and S204 are repeated until a determination of Yes is obtained in Step S253.

In a case where a determination of Yes is obtained in Step S253, the process proceeds to Step S206, and the processing apparatus 200 divides the value of each pixel of each band in the hyperspectral image of the subject by a corresponding value in the spectral data of the white panel. This results in a hyperspectral image in which the effect of the luminance distribution of light from the light sources 122 is removed.

In the example illustrated in FIG. 4B, the order of the operations in Step S150 and the operations in Step S250 (other than Step S206) may be switched. That is, the operations included in Step S250 other than Step S206 may be performed first to generate a hyperspectral image of the subject, and thereafter the operations included in Step S100 may be performed to acquire the spectral data of the white pane. Then, each pixel value of the image of each band in the hyperspectral image of the subject may be divided by a corresponding value in the spectral data of the white panel to generate a final hyperspectral image.

As described above, even in a case where whether or not the amount of light is appropriate is evaluated on the basis of the hyperspectral image instead of the compressed image, substantially the same effect as in the example illustrated in FIG. 4A can be obtained. Note that whether or not the amount of light is appropriate may be evaluated on the basis of the compressed image and the hyperspectral image. For example, after Step S106 in the example illustrated in FIG. 4A, the operation in Step S154 illustrated in FIG. 4B may be performed, and the process may proceed to Step S105 in a case where a determination of No is made in Step S154 and to Step S107 in a case where a determination of Yes is made in Step S154. Similarly, after Step S205 in the example illustrated in FIG. 4A, the operation in Step S253 illustrated in FIG. 4B may be performed, and the process may proceed to Step S204 in a case where a determination of No is made in Step S253 and to Step S206 in a case where a determination of Yes is made in Step S253. In this manner, the processing apparatus 200 may determine whether or not the amount of light or the luminance is appropriate on the basis of at least one of the compressed image or the hyperspectral image. That is, the processing apparatus 200 may determine whether or not the amount of light or the luminance is appropriate on the basis of the compressed image, the hyperspectral image, or the compressed image and hyperspectral image.

In each of the above-described examples, in Step S203 or S253, whether or not the pixel value of each of pixels included in the compressed image or included in the image of each band of the hyperspectral image is within the predetermined range is determined. Instead of this determination or in addition to this determination, a determination based on image contrast may be made. For example, in a case where a contrast value calculated from the pixel values of pixels in the compressed image or the image of each band of the hyperspectral image exceeds a threshold, the processing apparatus 200 may perform processing in which the value of each pixel of the image of each band of the hyperspectral image of the subject is divided by a corresponding value in the spectral data of the white panel and the resulting value is output. The contrast value is an index value indicating the degree of spread of pixel values in a histogram representing the relationship between pixel value and pixel value frequency. The contrast value may be determined quantitatively on the basis of the half width, the difference between the largest and smallest pixel values, the variance, or the standard deviation of the histogram of the image, for example. In Step S203 in FIG. 4A or Step S253 in FIG. 4B, a contrast value may be calculated. In a case where the contrast value does not exceed the threshold, the process proceeds to Step S204, and the distance between the light sources 122 and the white panel may be adjusted within the specified range.

The contrast for each wavelength band of pixels included in the compressed image corresponds to the randomness in the encoding of the wavelength band. Thus, the performance of encoding can be increased by increasing the contrast, so that the convergence of the solution can be improved. Thus, in a case where whether or not the image data including information regarding the compressed image satisfies the predetermined conditions is to be determined, the reconstruction errors in the processing for reconstructing the images of the respective bands from the compressed image can be reduced by imposing the condition that the contrast value exceeds the threshold value. This makes it possible to generate more favorable hyperspectral images.

In each of the above-described examples, the imaging apparatus 100 generates a compressed image, and the processing apparatus 200 reconstructs a hyperspectral image from the compressed image. Instead of such a configuration, the imaging apparatus 100 itself may be configured to generate hyperspectral images. That is, the imaging apparatus 100 may be a hyperspectral camera. In that case, the imaging apparatus 100 is not limited to cameras that generate hyperspectral images by performing processing based on compressed sensing using the above-described filter array. The imaging apparatus 100 may be cameras that generate hyperspectral images using other methods. Hyperspectral images can be acquired by performing imaging using a spectroscopic element, such as a prism or grating, for example. In a case where a prism is used, when light from a target passes through the prism, the light is emitted from the emitting surface of the prism at an emission angle corresponding to its wavelength. In a case where a grading is used, when light from the target enters the grading, the light is diffracted at a diffraction angle corresponding to its wavelength. A hyperspectral image can be obtained by separating the light from the target into bands using a prism or grating and detecting the separated light on a band basis.

In a case where a hyperspectral camera using a different method from the compressed sensing method is used, instead of performing the operations in steps S103 and S106 illustrated in FIG. 4B, the imaging apparatus 100 may acquire a hyperspectral image of the white panel. Similarly, instead of performing the operations in steps S202 and S205 illustrated in FIG. 4B, the imaging apparatus 100 may acquire a hyperspectral image of the subject.

### Determination of Specified Range

Next, an example of a method for determining a specified range for the distance between the light sources 122 and a target will be described. The specified range may be determined using, for example, a method for searching for the upper and lower limits of a range in which changes in the spectral shape of light from the light sources 122 are sufficiently small. The specified range is determined before the operations illustrated in FIG. 4A or 4B are performed.

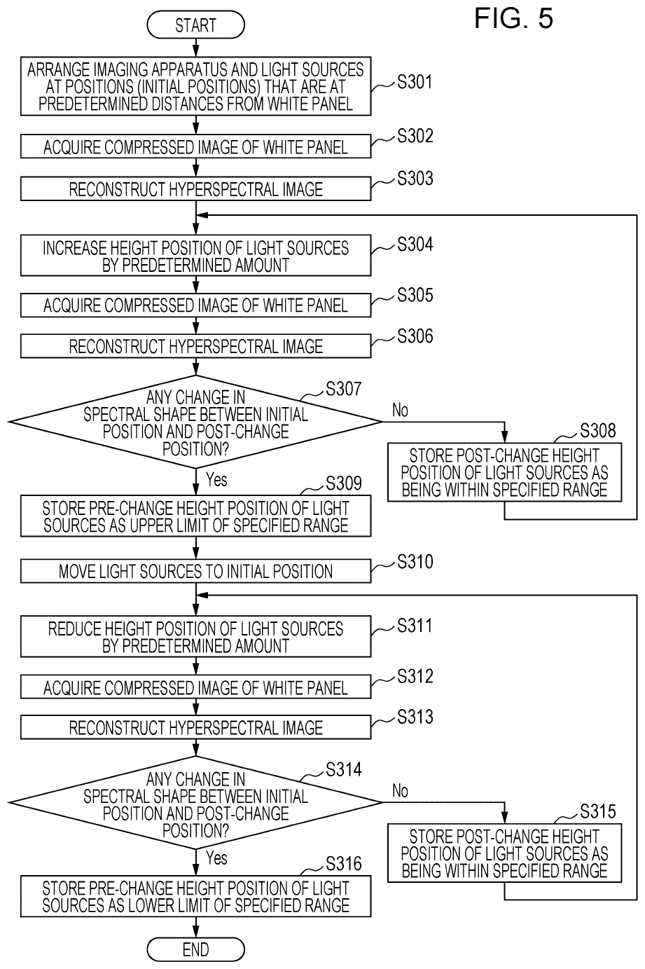

FIG. 5 is a flowchart illustrating an example of a method for determining the specified range. In this example, similarly to as in the example illustrated in FIG. 4A, the imaging apparatus 100 acquires a compressed image from which a hyperspectral image can be reconstructed. The processing apparatus 200 reconstructs a hyperspectral image on the basis of the compressed image. The method illustrated in FIG. 5 includes the operations in Steps S301 to S316. In the following, the operation in each step will be described.

In Step S301, the imaging apparatus 100 and the light sources 122 are arranged at positions (hereinafter referred to as “initial positions”) that are at predetermined distances from the white panel. This operation may be manually performed by the user or may be performed by the adjustment apparatus 130 in accordance with an instruction from the processing apparatus 200.

In Step S302, the processing apparatus 200 causes the imaging apparatus 100 to perform image capturing to acquire a compressed image of the white panel.

In Step S303, the processing apparatus 200 reconstructs a hyperspectral image from the compressed image acquired in Step S302. This reconstruction processing is substantially the same as that in Step S106 illustrated in FIG. 4A.

In Step S304, the processing apparatus 200 causes the adjustment apparatus 130 to increase the position of the light sources 122 in the height direction by a predetermined amount (for example, 0.5 mm, 1 cm, 2 cm, or the like). This increases the distance between the light sources 122 and the white panel by the predetermined amount (also referred to as a “unit length”).

In Step S305, the processing apparatus 200 causes the imaging apparatus 100 to perform image capturing again to acquire a compressed image of the white panel.

In Step S306, the processing apparatus 200 reconstructs a hyperspectral image from the compressed image acquired in Step S305. This reconstruction processing is also substantially the same as that in Step S106 illustrated in FIG. 4A.

In Step S307, the processing apparatus 200 compares the hyperspectral image reconstructed in Step S303 and the hyperspectral image reconstructed in Step S306 with each other to determine whether or not the spectral shape has changed between when the light sources 122 are at the initial position and when the light sources 122 are at the post-change position.

Whether or not the spectral shape has changed may be determined using, for example, Spectral Angle Mapper (SAM). In the following, an example of a method for determining the presence or absence of a change in spectral shape using SAM will be described.

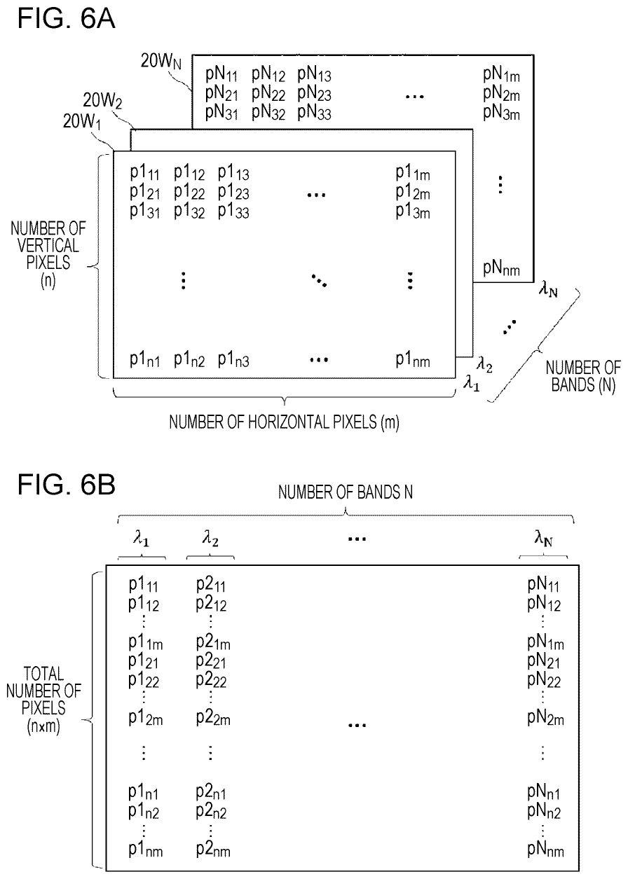

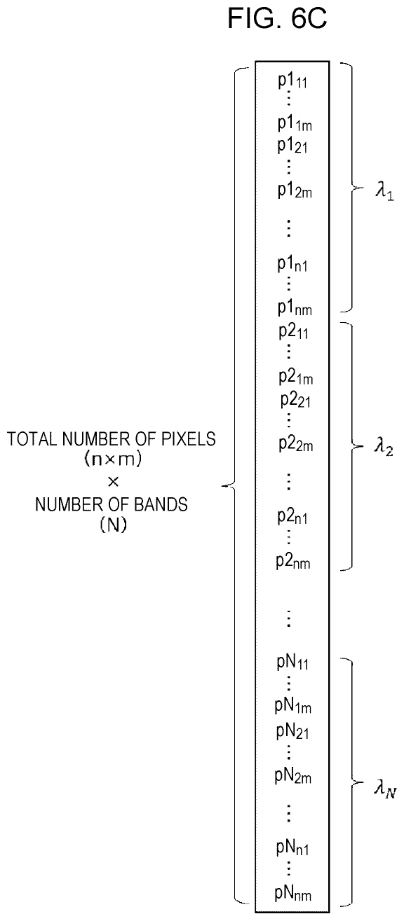

FIG. 6A is a diagram illustrating an example of the data structure of a hyperspectral image. In the example illustrated in FIG. 6A, the hyperspectral image is represented as a collection of N images 20W₁, 20W₂, . . . , 20W_{N}. The data of a hyperspectral image having such a structure is called a “hyperspectral data cube”. In this case, N is the total number of wavelength bands included in the target wavelength range and is an integer greater than or equal to four. Here, k=1, 2, . . . , N, and the k-th image 20Wₖ corresponds to the k-th wavelength band λₖ. In this case, a center wavelength λₖ of the k-th wavelength band will be used as a reference sign indicating the k-th wavelength band. Let m be the number of pixels in the horizontal direction and n be the number of pixels in the vertical direction in each of the images 20W₁, 20W₂, . . . , 20W_{N}, and let pkᵢⱼ be the pixel vale of the pixel in the i-th row and j-th column of the k-th image 20Wₖ. A hyperspectral image can then be expressed as the following N n×m matrices.

$$( \begin{matrix}p {1}_{11} & … & p {1}_{1 m} \\ ⋮ & ⋱ & ⋮ \\ p {1}_{n 1} & … & p {1}_{nm}\end{matrix} ) , ( \begin{matrix}p {2}_{11} & … & p {2}_{1 m} \\ ⋮ & ⋱ & ⋮ \\ p {2}_{n 1} & … & p {2}_{nm}\end{matrix} ) , … ( \begin{matrix}{pN}_{11} & … & {pN}_{1 m} \\ ⋮ & ⋱ & ⋮ \\ {pN}_{n 1} & … & {pN}_{nm}\end{matrix} )$$

Note that the hyperspectral image does not necessarily have a three-dimensional array data structure as illustrated in FIG. 6A and may have, for example, a two-dimensional array data structure as illustrated in FIG. 6B or a one-dimensional array data structure as illustrated in FIG. 6C. In the example illustrated in FIG. 6B, information regarding the images of N wavelength bands is arranged horizontally, and the pixel values of n×m pixels of the image of each wavelength band are arranged vertically. In the example illustrated in FIG. 6C, the pixel values of all pixels of the images of all the wavelength bands are arranged in one column. In this manner, the data structure of a hyperspectral image can be freely determined.

The hyperspectral image can be considered to be an image in which each pixel has pixel values for the N respective wavelength bands. The pixel values of each pixel may be expressed as an N-dimensional vector. The N-dimensional vector is a vector whose components are the pixel values for the N respective bands. Specifically, the pixel values of the pixel in the i-th row and j-th column may be represented by the following N-dimensional vector.

$$( \begin{matrix}p {1}_{ij} \\ p {2}_{ij} \\ ⋮ \\ {pN}_{ij}\end{matrix} )$$

A change in spectrum at a certain pixel can be evaluated by the angle between the pre-change vector and the post-change vector at the pixel. For example, suppose that the pre-change vector and post-change vector at the pixel in the i-th row and j-th column are the following vectors aᵢⱼ and bᵢⱼ.

$${α}_{ij} = ( \begin{matrix}p {11}_{ij} \\ p {12}_{ij} \\ ⋮ \\ p 1 {N}_{ij}\end{matrix} ) , {b}_{ij} = ( \begin{matrix}p {21}_{ij} \\ p {22}_{ij} \\ ⋮ \\ p 2 {N}_{ij}\end{matrix} )$$

In this case, p1kᵢⱼ represents a pre-change pixel value for the k-th band at the pixel in the i-th row and j-th column, and p2kᵢⱼ represents a post-change pixel value for the k-th band at the pixel in the i-th row and j-th column. The angle between the vector aᵢⱼ and the vector bᵢⱼ is represented by the following θᵢⱼ.

$${θ}_{ij} = {cos}^{- 1} \frac{{a}_{ij} \cdot {b}_{ij}}{\vert {a}_{ij} \vert \vert {b}_{ij} \vert}$$

By obtaining, for each pixel, the angle θⱼ between the two vectors, which are the pre-change and post-change vectors, information regarding the two-dimensional distribution of changes in spectrum can be obtained. In a case where the angle is 0°, the spectral shapes of both vectors are equal at the pixel. In a case where the absolute value of the angle is greater than 0°, the spectral shapes of both vectors are different at the pixel. In practice, the absolute value of the angle may be greater than 0° due to measurement errors even when the spectral shapes of both vectors are equal. In addition to errors originating from the imaging apparatus 100, the required hyperspectral image quality or error tolerance varies depending on the image capturing target. Thus, the processing apparatus 200 may determine that the spectral shape has changed, in a case where an integral value T or an average value A of the absolute values of the angles θᵢⱼ at the pixels of a hyperspectral image (hereinafter also referred to as “spectral angle”) is greater than or equal to a threshold, each angle being obtained between two vectors representing the pre-change and post-change spectra at a corresponding one of the pixels. The integral value T and the average value A are expressed by the following equations.

$$T = {\sum }_{i , j} \vert {θ}_{ij} \vert$$

$$A = \frac{1}{nm} {\sum }_{i , j} \vert {θ}_{ij} \vert$$

Alternatively, the processing apparatus 200 may determine that the spectral shape has changed, in a case where the absolute value of the spectral angle at a representative pixel of the hyperspectral image is greater than or equal to the threshold or where the absolute values of the spectral angles at representative pixels of the hyperspectral image are greater than or equal to the threshold. The threshold may be set to, for example, a value such as 1°, 3°, or 5°. The threshold is set to an appropriate value according to the purpose or application.

In a case where it is determined in Step S307 that the spectral shape has not changed, the process proceeds to Step S308. In Step S308, the processing apparatus 200 causes the storage device to store the post-change height position of the light sources 122 as being within the specified range. Thereafter, the process returns to Step S304, and the processing apparatus 200 causes the adjustment apparatus 130 to increase the height position of the light sources 122 by a predetermined amount again. Thereafter, the acquisition of a compressed image in Step S305, the reconstruction of a hyperspectral image in Step S306, and determination in Step S307 are performed again. The operations in Steps S304 to S308 are repeated until it is determined in Step S307 that the spectral shape has changed. In a case where it is determined that the spectral shape has changed, the process proceeds to Step S309.

In Step S309, the processing apparatus 200 causes the storage device to store, as the upper limit of the specified range, the position of the light sources 122 that was obtained immediately before the position was changed in Step S304 in the height direction.

After Step S309, the processing apparatus 200 performs the operation substantially the same as above while moving the light sources 122 downward from the initial position.

In Step S310, the processing apparatus 200 causes the adjustment apparatus 130 to move the light sources 122 to the initial position.

In Step S311, the processing apparatus 200 causes the adjustment apparatus 130 to reduce the position of the light sources 122 in the height direction by a predetermined amount. This reduces the distance between the light sources 122 and the white panel by the predetermined amount (namely, the unit length).

In Step S312, the processing apparatus 200 causes the imaging apparatus 100 to perform image capturing to acquire a compressed image of the white panel.

In Step S313, the processing apparatus 200 reconstructs a hyperspectral image from the compressed image acquired in Step S312.

In Step S314, the processing apparatus 200 compares the hyperspectral image reconstructed in Step S303 and the hyperspectral image reconstructed with each other in Step S313 to determine whether or not the spectral shape has changed between when the light sources 122 are at the initial position and when the light sources 122 are at the post-change position. The determination method is the same as that in Step S307.

In a case where it is determined in Step S314 that the spectral shape has not changed, the process proceeds to Step S315. In Step S315, the processing apparatus 200 causes the storage device to store the post-change height position of the light sources 122 as being within the specified range. Thereafter, the process returns to Step S311, and the processing apparatus 200 causes the adjustment apparatus 130 to reduce the height position of the light sources 122 by the predetermined amount again. Thereafter, the acquisition of a compressed image in Step S312, the reconstruction of a hyperspectral image in Step S313, and determination in Step S314 are performed again. The operations in Steps S311 to S315 are repeated until it is determined in Step S314 that the spectral shape has changed. In a case where it is determined that the spectral shape has changed, the process proceeds to Step S316.

In Step S316, the processing apparatus 200 causes the storage device to store, as the lower limit of the specified range, the position of the light sources 122 that was obtained immediately before the position was changed in Step S311 in the height direction.

The above-described operation makes it possible to determine the specified range, in which the spectral shape is regarded as constant, for the distance between the light sources 122 and the subject.

Note that in a case where the spectral shape has changed in the first operation from Steps S304 to S307, the process does not have to proceed to Step S309, and the processing apparatus 200 may change the initial position of the light sources 122 and then perform the processing illustrated in FIG. 5. Alternatively, in a case where the spectral shape has changed in the first operation from Steps S304 to S307, the processing apparatus 200 may repeat processing for generating a hyperspectral image while changing the position of the light sources 122 in the height direction to search for the upper and lower limits of the distance range in which the spectral shape does not change.

In the example illustrated in FIG. 5, the processing apparatus 200 determines the upper limit of the specified range first and then the lower limit; however, the lower limit may be determined first and then the upper limit. In that case, the order of the operation in Steps S304 to S309 and the operation in Steps S311 to S316 is switched.

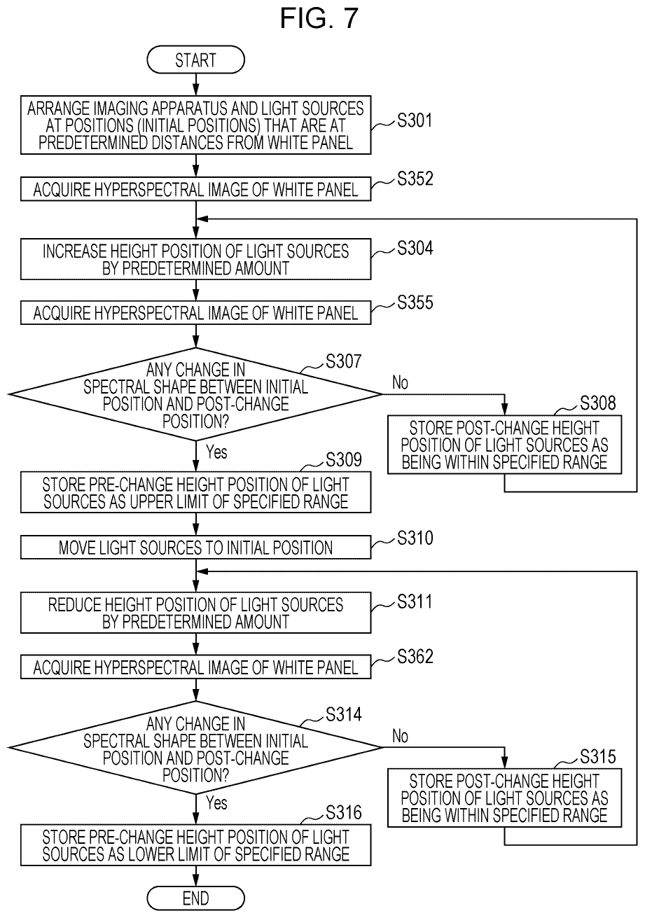

In the example illustrated in FIG. 5, the imaging apparatus 100 acquires a compressed image, and the processing apparatus 200 generates a hyperspectral image on the basis of the compressed image. The present disclosure is not limited to such an embodiment, and the imaging apparatus 100 itself may be configured to, for example, generate a hyperspectral image. In the following, an example of a method for determining the specified range in that case will be described while referring to FIG. 7.

FIG. 7 is a flowchart illustrating an example of a method for determining the specified range for the distance between the light sources 122 and the subject in a case where the imaging apparatus 100 acquires hyperspectral images. The flowchart illustrated in FIG. 7 differs from the flowchart illustrated in FIG. 5 in that Steps S302 and S303 are replaced by Step S352, Steps S305 and S306 are replaced by Step S355, and Steps S312 and S313 are replaced by Step S362. In the example illustrated in FIG. 7, in Steps S352, S355, and S362, the imaging apparatus acquires not a compressed image but a hyperspectral image. Except for this point, the operation illustrated in FIG. 7 is the same as that illustrated in FIG. 5. Even in the example illustrated in FIG. 7, similarly to as in the example illustrated in FIG. 5, an appropriate specified range can be determined.

### Example of Configuration of Imaging System

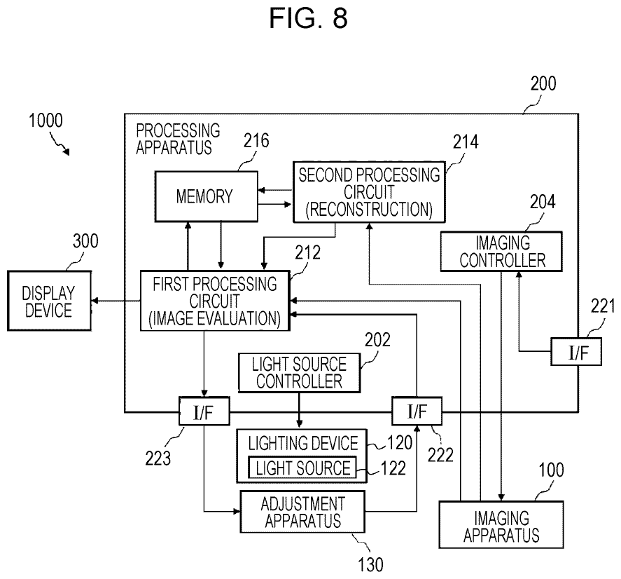

FIG. 8 is a block diagram illustrating an example of the configuration of the imaging system 1000 that performs the above-described method. The imaging system 1000 illustrated in FIG. 8 includes the imaging apparatus 100, the lighting device 120, the adjustment apparatus 130, the processing apparatus 200, and a display device 300. The lighting device 120 includes one or more light sources 122. The adjustment apparatus 130 has a mechanism, such as an actuator, that adjusts the distance between the one or more light sources 122 and the subject. The display device 300 is, for example, a display (monitor) such as a liquid crystal display or an organic light emitting diode (OLED) display, and displays results of processing performed by the processing apparatus 200. The imaging apparatus 100 in this example is a camera that generates a compressed image from which a hyperspectral image is reconstructed. The processing apparatus 200 reconstructs a hyperspectral image from the compressed image output from the imaging apparatus 100. The processing apparatus 200 may be directly connected to the imaging apparatus 100, the lighting device 120, the adjustment apparatus 130, and the display device 300 or may be indirectly connected to them via a wired network, a wireless network, or wired and wireless networks. Moreover, the functions of the processing apparatus 200 may be distributed among devices. For example, at least some of the functions of the processing apparatus 200 may be executed by an external computer such as a cloud server.

The processing apparatus 200 illustrated in FIG. 8 includes a light source controller 202, an imaging controller 204, a first processing circuit 212, a second processing circuit 214, and a memory 216.

The light source controller 202 controls the turning on, turning off, and light emission intensity of the one or more light sources 122 in the lighting device 120.

The imaging controller 204 controls the operation of the imaging apparatus 100. The imaging controller 204 sets, for example, the exposure time and gain of the imaging apparatus 100.

The first processing circuit 212 determines whether or not the luminance of the subject is appropriate on the basis of the image data output from the imaging apparatus 100, and controls the adjustment apparatus 130 on the basis of the determination result. The adjustment apparatus 130 adjusts the luminance of the subject to an appropriate range by changing the position of the one or more light sources 122 in response to control performed by the first processing circuit 212. The first processing circuit 212 also causes the display device 300 to display processing results, such as a hyperspectral image generated on the basis of the compressed image.

The second processing circuit 214 performs reconstruction processing on the basis of the compressed image to generates a hyperspectral image. In the present embodiment, the second processing circuit 214 and the first processing circuit 212 are independent circuits of each other; however, these circuits may be realized as a single circuit. Such a single circuit may also provide the functions of the light source controller 202 and the imaging controller 204.

The memory 216 is a storage device that stores computer programs executed by the first processing circuit 212 and the second processing circuit 214 and various types of data generated in the process of processing. The memory 216 stores, for example, data indicating the above-described specified range for the distance, data indicating the spectral transmittance of the filter array in the imaging apparatus 100, and spectral data indicating a hyperspectral image of the white panel.

### Example of Operation for When Light Source Position is Adjusted

In a case where the position of the one or more light sources 122 is to be adjusted, first, parameters of the imaging apparatus 100 are set from an external input device via an input interface (I/F) 221. The parameters include, for example, exposure time and gain. The parameters may be set in accordance with, for example, an operation performed by the user using an input device.

Thereafter, the white panel is arranged on the stage, and image capturing is started. Image capturing may be performed in response to an instruction from an external input device via the input interface 221. As a result of image capturing, data of a compressed image is output from the imaging apparatus 100. The data of the compressed image is sent to the first processing circuit 212 and the second processing circuit 214. The second processing circuit 214 generates a hyperspectral image on the basis of the compressed image. The generated hyperspectral image is sent to the first processing circuit 212. In contrast, information indicating the distance between the one or more light sources 122 and the white panel is sent to the first processing circuit 212 from the adjustment apparatus 130 via an input interface 222.

The first processing circuit 212 evaluates, on the basis of the input distance information and at least one of the compressed image or the hyperspectral image, the luminance distribution of the white panel by performing, for example, processing in Step S104 illustrated in FIG. 4A or Step S154 illustrated in FIG. 4B. The first processing circuit 212 causes the adjustment apparatus 130 to change the distance between the one or more light sources 122 and the white panel such that the luminance distribution is optimized. The first processing circuit 212 sends a control signal to the adjustment apparatus 130 via an interface 223. The adjustment apparatus 130 changes, in response to the control signal, the position of one or more the light sources 122 within a preset specified range. As a result, the optimal distance between the one or more light sources 122 and the white panel or the optimal position of the one or more light sources 122 is determined.

In a case where a hyperspectral image of the white panel is acquired when the distance between the one or more light sources 122 and the white panel is optimized, it becomes possible to acquire a hyperspectral image of the subject. The user removes the white panel from the stage, and arranges the subject on the stage. Substantially the same operation as described above is also performed on the subject. That is, the distance between the one or more light sources 122 and the subject is adjusted such that the luminance is optimized. A compressed image is acquired in a state where the distance is optimized.

Note that the brightness of light is inversely proportional to the square of the distance from the light source. Thus, the first processing circuit 212 may determine the optimal distance from the optimal brightness values of the white panel and subject on the basis of the relational expression between distance and brightness.

### Example of Operation for Determining Specified Range

In a case where the specified range is to be determined, first, parameters, such as exposure time and gain, of the imaging apparatus 100 are set via the input interface 221.

Subsequently, the white panel is arranged on the stage, and image capturing is started. Data of a compressed image is output from the imaging apparatus 100 to the first processing circuit 212 and the second processing circuit 214. The second processing circuit 214 generates a hyperspectral image of the white panel on the basis of the compressed image. The hyperspectral image is sent to the first processing circuit 212.

In contrast, information regarding the distance between the one or more light sources 122 and the white panel is sent to the first processing circuit 212 from the adjustment apparatus 130 via the input interface 222. The first processing circuit 212 evaluates, on the basis of the distance information and at least one of the compressed image or the hyperspectral image, a change in spectral shape from the spectral shape obtained in a case where the one or more light sources 122 are at the initial position. The first processing circuit 212 determines, using the procedure illustrated in FIG. 5 or 7, the upper and lower limits of the specified range of distance in which the spectral shape does not change.

### Manual Adjustment of Lighting Conditions

In the present embodiment, the processing apparatus 200 and the adjustment apparatus 130 automatically adjust the position of the one or more light sources 122; however, the user may perform this adjustment manually. In that case, the imaging system may have, instead of the adjustment apparatus 130 that automatically adjusts the distance therebetween, a mechanism that can manually adjust the distance between the one or more light sources 122 and the white panel. The first processing circuit 212 may be configured to display the compressed image, the hyperspectral image, or the compressed and hyperspectral images on the display device 300. In a case where the user determines that the luminance is inappropriate by visually observing the brightness of the displayed image, the user may manually adjust the distance between the one or more light sources 122 and the white panel.

Moreover, the processing apparatus 200 may determine the specified range for the distance between the one or more light sources 122 and the subject and thereafter cause the display device 300 to display information regarding the specified range. In a case where the pixel value of each of pixels included in the compressed image or hyperspectral image of the white panel or subject is outside the predetermined range, the user may manually change the distance between the one or more light sources 122 and the white panel or subject such that the distance falls within the specified range displayed on the display device 300.

The mechanism that manually adjusts the distance between the one or more light sources 122 and the subject may be designed in advance such that its range of motion falls within the specified range. Such a design makes it easier to set the lighting conditions to achieve a suitable state because it avoids the distance being outside the specified range.

Moreover, the specified range may be determined in advance by the manufacturer of the imaging system, and the manual or other instructions may state, for example, “Please perform white panel adjustment within the specified range”. The user can set the lighting conditions to achieve an optimal state by following the instruction and adjusting the distance between the one or more light sources 122 and the subject within the specified range.

These methods for manually adjusting the lighting conditions may be used not only for configurations that adjust the distance between the one or more light sources 122 and the subject and may similarly be applied to embodiments in which the lighting conditions are adjusted by adjusting other parameters to be described later.

### Another Example of Method for Changing Lighting Conditions

In the above-described embodiment, the processing apparatus 200 changes the lighting conditions by changing the distance between the one or more light sources 122 and the white panel and the distance between the one or more light sources 122 and the subject; however, the processing apparatus 200 is not limited to this. For example, the lighting conditions may be changed by changing control parameters, such as the current or voltage for driving the one or more light sources 122. Even in that case, the processing apparatus 200 changes the lighting conditions such that the luminance distribution at the subject's location does not change.

FIG. 9 is a flowchart illustrating an example of a hyperspectral image generation method for a case where the lighting conditions are changed by changing a control parameter for driving the one or more light sources. In the example illustrated in FIG. 9, the control parameter is a current for driving the one or more light sources 122 (hereinafter also referred to as a “drive current”). The control parameter is not necessarily the current and may also be a voltage for driving the one or more light sources 122. Alternatively, in a case where the one or more light sources 122 are, for example, one or more light sources such as LEDs driven by a PWM signal, the control parameter may be the duty ratio of the PWM signal.

The method illustrated in FIG. 9 includes Step S170 for acquiring the spectral data of the white panel and Step S270 for acquiring a hyperspectral image of the subject. Step S170 differs from Step S100 illustrated in FIG. 4A in that Step S173 is added between Step S102 and Step S103, and Step S105 is replaced by Step S175. Step S270 differs from Step S200 illustrated in FIG. 4A in that Step S204 is replaced by Step S274. In the following, points different from the example illustrated in FIG. 4A will be mainly described.

In the example illustrated in FIG. 9, the lighting conditions are changed by changing the drive current for the one or more light sources 122 instead of changing the distance between the one or more light sources 122 and the subject. The processing apparatus 200 sets, in Step S173, the drive current for the one or more light sources 122 to an initial value. In a case where it is determined in Step S104 that the pixel values of pixels included in the compressed image of the white panel do not satisfy the predetermined condition, the process proceeds to Step S175, and the processing apparatus 200 changes the drive current for the one or more light sources 122 within a specified range. For example, the drive current is increased or decreased by a predetermined amount. Similarly, in a case where it is determined in Step S203 that the pixel values of pixels included in the compressed image of the subject do not satisfy the predetermined condition, the process proceeds to Step S274, and the processing apparatus 200 changes the drive current for the one or more light sources 122 within the specified range. The specified range in this example is a current range in which the spectral shape of light from the one or more light source 122 can be regarded as nearly constant at the subject's location. The processing apparatus 200 may be configured to change the drive current by, for example, changing the voltage for driving the one or more light sources 122. Even using the method illustrated in FIG. 9, similarly to using the method illustrated in FIG. 4A, a hyperspectral image of the subject can be efficiently acquired.

In the example illustrated in FIG. 9, the processing apparatus 200 determines whether or not the lighting conditions are appropriate for a compressed image; however, as in the example illustrated in FIG. 4B, the processing apparatus 200 may determine whether or not the lighting conditions are appropriate for a hyperspectral image. That is, even in the example illustrated in FIG. 9 in which the control parameter, such as the drive current or voltage for the one or more light sources 122 is adjusted, transformation substantially the same that from FIG. 4A to FIG. 4B is possible.

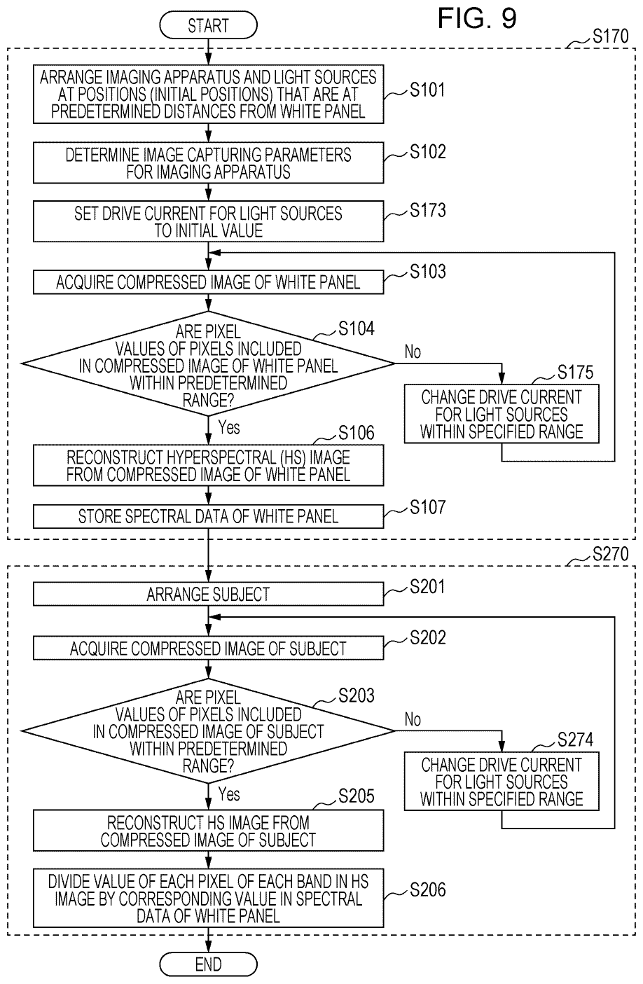

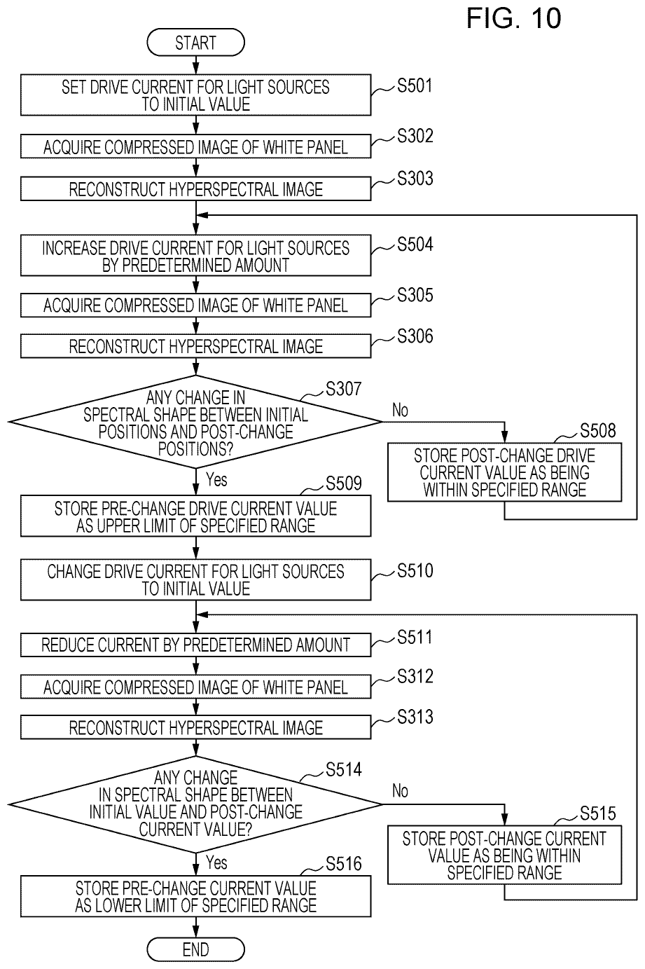

FIG. 10 is a flowchart illustrating an example of a method for determining a specified range for the drive current for the one or more light sources 122. In the flowchart illustrated in FIG. 10, Steps S301, S304, S308, S309, S310, S311, S314, S315, and S316 in FIG. 5 are replaced by Steps S501, S504, S508, S509, S510, S511, S514, S515, and S516, respectively. The basic procedure is substantially the same as that in the example illustrated in FIG. 5. In the example illustrated in FIG. 10, the drive current for the one or more light sources 122 is increased or decreased by a predetermined amount, and every time the drive current is increased or decreased, the specified range is determined by determining whether or not the spectral shape has changed. In this example, the specified range for the drive current for the one or more light sources 122 is determined; however, substantially the same method can be used to determine the specified ranges for other controls parameters, such as the drive voltage or the duty ratio of the PWM signal.

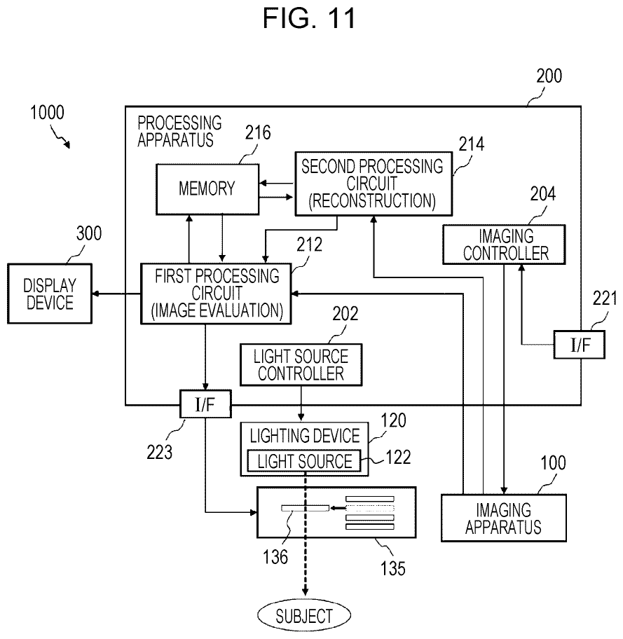

In the above-described embodiment, the lighting conditions are changed using (A) the method for changing the distance between the one or more light sources 122 and the white panel and the distance between the one or more light sources 122 and the subject within the specified range within the specified range or (B) the method for changing a control parameter for driving the one or more light sources 122 within the specified range. Under conditions where the spectral shape at the subject's location does not change, the lighting conditions may be changed using other methods different from these methods. For example, the lighting conditions may be changed by switching, for example, a light reduction filter such as an ND filter that may be arranged between the one or more light sources 122 and the subject (or a calibration subject such as the white panel). Even in this case, the light reduction filter is switched such that the spectral shape at the subject's location does not change before and after the change. The imaging system may have, for example as illustrated in FIG. 11, a mechanism 135 between the one or more light sources 122 and the subject that inserts one light reduction filter selected from light reduction filters 136 having different transmittances. The mechanism 135 may include a device such as an actuator that inserts or removes, in response to an instruction from the processing apparatus 200, each light reduction filter 136 along or from the optical path from the one or more light sources 122 to the subject. In such an embodiment, the processing apparatus 200 may be configured to change the lighting conditions by causing the mechanism 135 to switch, in a case where the pixel values of pixels in the compressed image or hyperspectral image do not satisfy predetermined conditions, the light reduction filter 136 inserted between the one or more light sources 122 and the subject. Each of the light reduction filters 136 may be a filter with low wavelength dependency of transmittance and small in-plane irregularities. In embodiments in which the lighting conditions are changed by switching the light reduction filter 136, the operation for switching the light reduction filter 136 may be performed instead of adjustment of the distance between the one or more light sources 122 and the subject (or the height of the one or more light sources 122) in the operation illustrated in FIG. 4A or 4B and FIG. 5 or 7. The light reduction filter 136 may be switched automatically or manually. In embodiments in which the light reduction filter 136 is switched manually, for example, in a case where a determination of No is obtained in Step S104 or S203 illustrated in FIG. 4A or 4B, the processing apparatus 200 may cause the display device 300 to display information for identifying the light reduction filters 136 that are switching candidates. This allows the user to know which light reduction filter to switch to.

### Hyperspectral Image Generation Based on Compressed Sensing

Next, examples of the configuration of the imaging apparatus 100 for acquiring compressed images and the hyperspectral image generation method based on compressed sensing will be described in more detail.

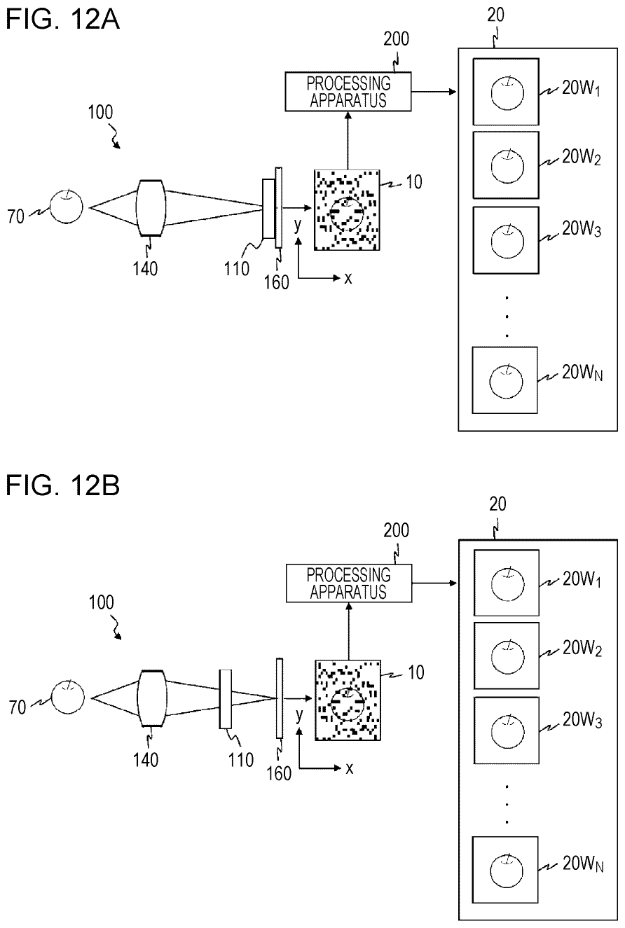

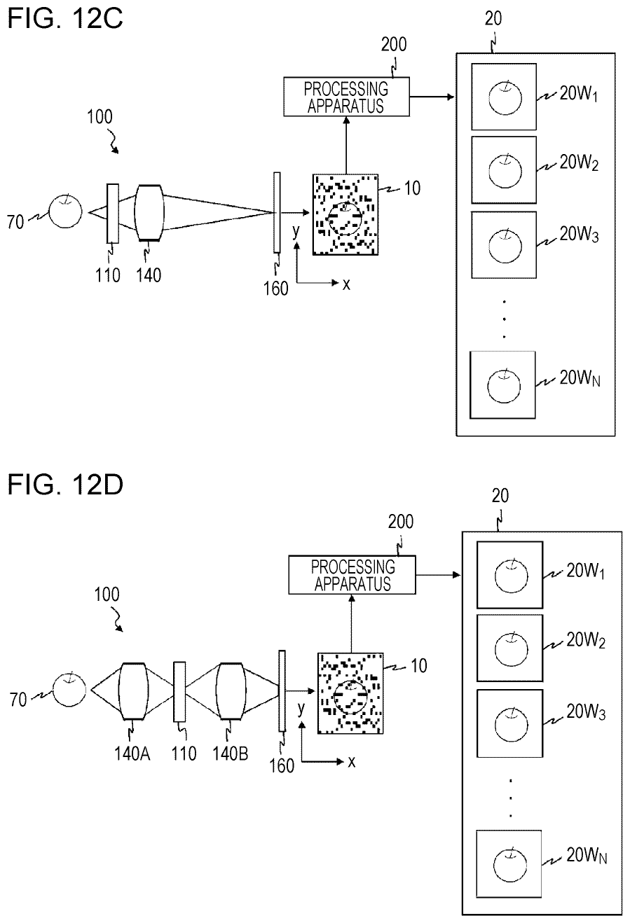

FIG. 12A is a diagram schematically illustrating an example of the configuration of the imaging apparatus 100 that acquires compressed images and an example of processing performed by the processing apparatus 200. This imaging apparatus 100 has substantially the same configuration as the imaging apparatus disclosed in U.S. Pat. No. 9,599,511. The imaging apparatus 100 includes an optical system 140, a filter array 110, and the image sensor 160. The optical system 140 and the filter array 110 are arranged along an optical path of incident light from a target 70, which is a subject. The filter array 110 in the example illustrated in FIG. 12A is arranged between the optical system 140 and the image sensor 160.

FIG. 12A illustrates an apple as an example of the target 70. The target 70 is not limited to an apple, and may be any object. The image sensor 160 generates data of a compressed image 10, in which information regarding wavelength bands is compressed as a two-dimensional monochrome image. The processing apparatus 200 generates data representing images corresponding one-to-one to wavelength bands included in a certain target wavelength range, on the basis of the data of the compressed image 10 generated by the image sensor 160. As described above, suppose that the number of wavelength bands included in the target wavelength range is N (N is an integer greater than or equal to four). In the following description, N images generated on the basis of the compressed image may be referred to as a reconstructed image 20W₁, a reconstructed image 20W₂, . . . , a reconstructed image 20W_{N}, and these images may be collectively referred to as a “hyperspectral image 20”.

The filter array 110 in the present embodiment is an array of filters arranged in rows and columns and having translucency. The filters include different kinds of filters having different spectral transmittances from each other, that is, having different wavelength dependencies on luminous transmittance from each other. The filter array 110 modulates the intensity of incident light on a wavelength basis and outputs the resulting light. This process performed by the filter array 110 may be referred to as “encoding”, and the filter array 110 may be referred to as an “encoding element”.

In the example illustrated in FIG. 12A, the filter array 110 is arranged near or directly on the image sensor 160. In this case, “near” refers to the filter array 110 being close enough to the image sensor 160 that an image of light from the optical system 140 is formed on the surface of the filter array 110 in a state where the image of light has a certain degree of clearness. “Directly on” refers to the filter array 110 and the image sensor 160 being close to each other to an extent that there is hardly any gap therebetween. The filter array 110 and the image sensor 160 may be formed as a single device.

The optical system 140 includes at least one lens. In FIG. 12A, the optical system 140 is illustrated as one lens; however, the optical system 140 may be a combination of lenses. The optical system 140 forms an image on an imaging surface of the image sensor 160 through the filter array 110.

The filter array 110 may be arranged so as to be spaced apart from the image sensor 160. FIGS. 12B to 12D are diagrams illustrating examples of the configuration of the imaging apparatus 100, in which the filter array 110 is arranged so as to be spaced apart from the image sensor 160. In the example illustrated in FIG. 12B, the filter array 110 is arranged between the optical system 140 and the image sensor 160 and at a position spaced apart from the image sensor 160. In the example illustrated in FIG. 12C, the filter array 110 is arranged between the target 70 and the optical system 140. In the example illustrated in FIG. 12D, the imaging apparatus 100 includes two optical systems 140A and 140B, and the filter array 110 is arranged between the optical systems 140A and 140B. As in these examples, an optical system including one or more lenses may be arranged between the filter array 110 and the image sensor 160.

The image sensor 160 is a monochrome light detection device having light detection elements (also referred to as “pixels” in this specification) arranged two-dimensionally. The image sensor 160 may be, for example, a charge-coupled device (CCD), a complementary metal-oxide-semiconductor (CMOS) sensor, or an infrared array sensor. The light detection elements include, for example, a photodiode. The image sensor 160 is not necessarily a monochrome sensor. For example, a color sensor may be used. A color sensor may include, for example, red (R) filters that allow red light to pass therethrough, green (G) filters that allow green light to pass therethrough, and blue (B) filters that allow blue light to pass therethrough. A color sensor may further include IR filters that allow infrared rays to pass therethrough. In addition, a color sensor may also include transparent filters that allow all red, green, and blue light to pass therethrough. By using the color sensor, the amount of information regarding wavelengths can be increased, so that the reconstruction accuracy of a hyperspectral image 20 can be increased. A wavelength region as an acquisition target may be freely determined. The wavelength region is not limited to the visible wavelength region and may also be the ultraviolet wavelength region, the near infrared wavelength region, the mid-infrared wavelength region, or the far-infrared wavelength region.

The processing apparatus 200 may be a computer including one or more processors and one or more storage media, such as a memory. The processing apparatus 200 generates data of the reconstructed images 20W₁, 20W₂, . . . , 20W_{N} on the basis of the compressed image 10 acquired by the image sensor 160.

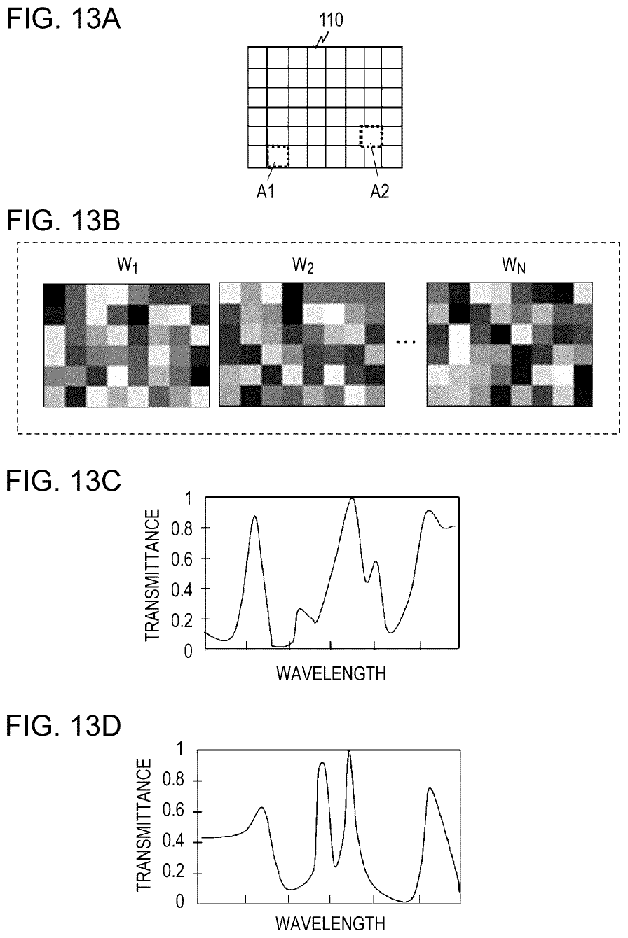

FIG. 13A is a diagram schematically illustrating an example of the filter array 110. The filter array 110 has regions arranged two-dimensionally. In this specification, these regions may be referred to as “cells”. In each region, an optical filter having a spectral transmittance set individually is arranged. Spectral transmittance is expressed by a function T(λ), where the wavelength of incident light is 2. The spectral transmittance T(λ) may have a value greater than or equal to 0 and less than or equal to 1.

In the example illustrated in FIG. 13A, the filter array 110 has 48 rectangular regions arranged in 6 rows and 8 columns. This is merely an example, and a larger number of regions than this may be provided in actual applications. The number of regions may be about the same as, for example, the number of pixels of the image sensor 160. The number of filters included in the filter array 110 is determined depending on applications, for example, within a range from several tens to several tens of millions.

FIG. 13B is a diagram illustrating an example of a spatial distribution of luminous transmittance of each of wavelength bands W₁, W₂, . . . , W_{N} included in the target wavelength range. In the example illustrated in FIG. 13B, differences in shading between the regions represent differences in transmittance. The lighter the shade of the region, the higher the transmittance. The darker the shade of the region, the lower the transmittance. As illustrated in FIG. 13B, the spatial distribution of luminous transmittance differs depending on a wavelength band basis.

FIG. 13C is a diagram illustrating an example of the spectral transmittance of a region A1, and FIG. 13D is a diagram illustrating an example of the spectral transmittance of a region A2, the regions A1 and A2 being included in the filter array 110 illustrated in FIG. 13A. The spectral transmittance of the region A1 is different from that of the region A2. In this manner, the spectral transmittance of the filter array 110 differs on a region basis. Note that all the regions do not necessarily have different spectral transmittances from each other. At least some of the regions included in the filter array 110 have different spectral transmittances from each other. The filter array 110 includes two or more filters that have different spectral transmittances from each other. In one example, the number of patterns of spectral transmittances of the regions included in the filter array 110 may be the same as N, which is the number of wavelength bands included in the target wavelength range, or higher than N. The filter array 110 may be designed such that more than half of the regions have different spectral transmittances from each other.

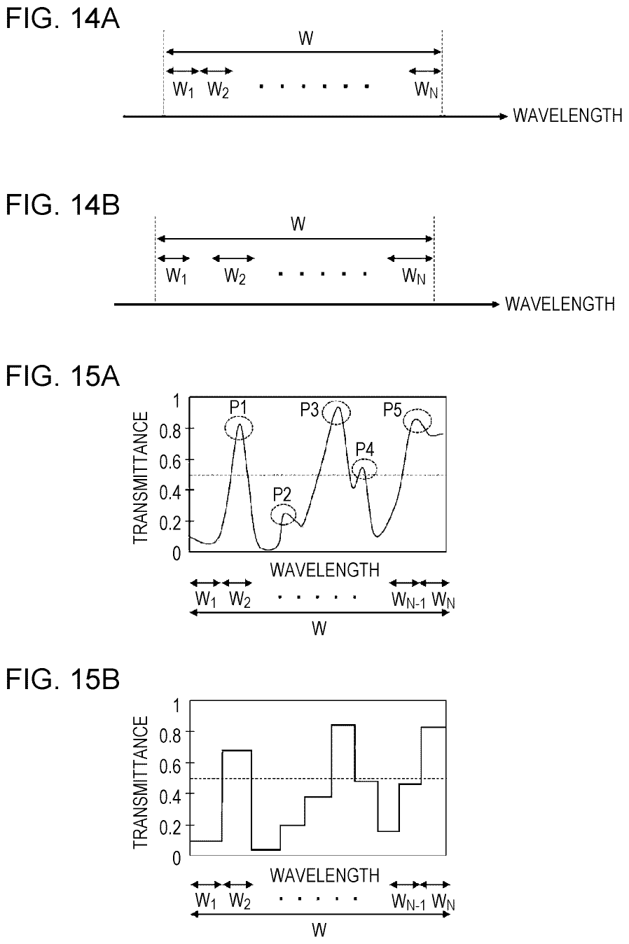

FIGS. 14A and 14B are diagrams for describing relationships between a target wavelength range W and the wavelength bands W₁, W₂, . . . , W_{N} included in the target wavelength range W. The target wavelength range W may be set to various ranges depending on applications. The target wavelength range W may have, for example, a wavelength range of visible light of about 400 nm to about 700 nm, a wavelength range of near infrared rays of about 700 nm to about 2500 nm, or a wavelength range of near ultraviolet rays of about 10 nm to about 400 nm. Alternatively, the target wavelength range W may be a wavelength range of mid-infrared rays or that of far-infrared rays. In this manner, the wavelength range to be used is not limited to the visible light range. In this specification, not only visible light but also all radiation including infrared rays and ultraviolet rays will be referred to as “light”.

In the example illustrated in FIG. 14A, N is set to any integer greater than or equal to 4, the target wavelength range W is equally divided into N sections, and these N wavelength regions are referred to as the wavelength bands W₁, W₂, . . . , and W_{N}. Note that the example is not limited to this one. The wavelength bands included in the target wavelength range W may be freely set. For example, the wavelength bands may have different bandwidths. There may be an overlap or a gap between adjacent wavelength bands among the wavelength bands. In the example illustrated in FIG. 14B, the wavelength bands have different bandwidths, and there is a gap between two adjacent wavelength bands among the wavelength bands. In this manner, the wavelength bands may be freely determined.

FIG. 15A is a diagram for describing characteristics of the spectral transmittance of a certain region of the filter array 110. In the example illustrated in FIG. 15A, regarding the wavelengths within the target wavelength range W, the spectral transmittance has local maxima P1 to P5 and local minima. In the example illustrated in FIG. 15A, the luminous transmittance within the target wavelength range W is normalized to have a maximum value of 1 and a minimum value of 0. In the example illustrated in FIG. 15A, the spectral transmittance has local maxima in wavelength ranges, such as the wavelength band W₂ and the wavelength band W_{N-1}. In this manner, the spectral transmittance of each region of at least two wavelength ranges among the wavelength bands W₁, W₂, . . . , W_{N} may be designed to have a local maximum. In the example illustrated in FIG. 15A, the local maxima P1, P3, P4, and P5 are greater than or equal to 0.5.

In this manner, the luminous transmittance of each region varies with wavelength. Thus, the filter array 110 allows a large portion of a certain wavelength range component of incident light to pass therethrough but does not allow large portions of other wavelength range components of incident light to pass therethrough. For example, the luminous transmittances of k wavelength bands out of N wavelength bands may be greater than 0.5, and the luminous transmittances of the other N-k wavelength bands may be less than 0.5, where k is an integer that satisfies 2≤k<N. If incident light is white light, which includes all the visible light wavelength components equally, the filter array 110 modulates, on a region basis, the incident light into light having discrete peaks in intensity for wavelengths and superposes and outputs light of these multiple wavelengths.

FIG. 15B is a diagram illustrating a result obtained by averaging spectral transmittances of each of the wavelength bands W₁, W₂, . . . , W_{N} illustrated in FIG. 15A. The average transmittance is obtained by integrating the spectral transmittance T(λ) for each wavelength band and performing division using the bandwidth of the wavelength band. In this specification, the value of average transmittance for each wavelength band obtained in this manner will be treated as the transmittance of the wavelength band. In this example, transmittance is prominently high in three wavelength ranges corresponding to the local maxima P1, P3, and P5. In particular, transmittance is higher than 0.8 in the two wavelength ranges corresponding to the local maxima P3 and P5.

In the example illustrated in FIGS. 13A to 13D, a gray scale transmittance distribution is assumed in which the transmittance of each region may have any value greater than or equal to 0 and less than or equal to 1. However, a gray scale transmittance distribution is not always needed. For example, a binary scale transmittance distribution may be used in which the transmittance of each region may have either a value of around 0 or a value of around 1. In a binary scale transmittance distribution, each region allows a large portion of light of at least two wavelength ranges among the wavelength ranges included in the target wavelength range to pass therethrough, and does not allow a large portion of light of the other wavelength ranges to pass therethrough. In this case, the “large portion” refers to about 80% or higher.

Some of all the cells, for example, half the cells may be replaced with transparent regions. Such transparent regions allow light of all the wavelength bands W₁, W₂, . . . , W_{N} included in the target wavelength range W to pass therethrough at similarly high transmittances, for example, 80% or higher. With such a configuration, the transparent regions may be arranged, for example, in a checkerboard manner. That is, the regions whose luminous transmittance varies with wavelength and the transparent regions may be arranged in an alternating manner in two directions of the arrayed regions in the filter array 110.

Data representing such a spatial distribution of the spectral transmittance of the filter array 110 is acquired beforehand on the basis of design data or by performing actual measurement calibration, and is stored in a storage medium of the processing apparatus 200. This data is used in arithmetic processing to be described later.

The filter array 110 may be formed using, for example, a multi-layer film, an organic material, a diffraction grating structure, or a microstructure including metal. In a case where a multi-layer film is used, for example, a dielectric multi-layer film or a multi-layer film including a metal layer may be used. In this case, the cells are formed such that at least one of the thicknesses, materials, or stacking orders of the layers of the multi-layer film are made different from cell to cell. As a result, spectral characteristics that are different from cell to cell can be realized. By using a multi-layer film, a sharp rising edge and a sharp falling edge can be realized for spectral transmittance. A configuration using an organic material can be realized by causing different cells to contain different pigments or dyes or by causing different cells to have stacks of layers of different materials. A configuration using a diffraction grating structure may be realized by causing different cells to have diffraction structures with different diffraction pitches or different depths. In a case where a microstructure including metal is used, the filter array 110 may be produced using plasmon effect spectroscopy.

Next, an example of signal processing performed by the processing apparatus 200 will be described. The processing apparatus 200 reconstructs a hyperspectral image 20, which is a multi-wavelength image, on the basis of a compressed image 10 output from the image sensor 160 and characteristics of a transmittance spatial distribution for each wavelength of the filter array 110. In this case, “multi-wavelength” refers to, for example, more wavelength ranges than 3-color wavelength ranges, which are RGB wavelength ranges, acquired by normal color cameras. The number of such wavelength ranges may be, for example, any number between 4 and about 100. The number of such wavelength ranges will be referred to as the “number of bands”. Depending on applications, the number of bands may exceed 100.

Data to be obtained is data of the hyperspectral image 20, and the data will be denoted by f. When the number of bands is N, f denotes data obtained by combining image data f₁, f₂, . . . , f_{N} corresponding to the N bands. The data f may be represented in various formats as illustrated in FIG. 6A, 6B, or 6C. In this case, as illustrated in FIG. 12A, suppose that the horizontal direction of the image is the x direction, and the vertical direction of the image is the y direction. When the number of pixels in the x direction for the image data to be obtained is m, and the number of pixels in the y direction for the image data to be obtained is n, each of the image data f₁, f₂, . . . , f_{N} has n×m pixel values. Thus, the data f is data having n×mx N elements. In contrast, data g of the compressed image 10 acquired by the filter array 110 through encoding and multiplexing has n×m elements. The data g can be expressed by the following Eq. (1).

$$g = Hf = H [ \begin{matrix}{f}_{1} \\ {f}_{2} \\ ⋮ \\ {f}_{N}\end{matrix} ] \qquad ( 1 )$$

In Eq. (1), f represents data of a hyperspectral image represented as a one-dimensional vector as illustrated in FIG. 6C. Each of f₁, f₂, . . . , f_{N} has n×m elements. Thus, the vector on the right side is a one-dimensional vector having n×m×N rows and one column. The data g of the compressed image is calculated as a one-dimensional vector having n×m rows and one column. A matrix H represents a conversion in which individual components f₁, f₂, . . . , f_{N} of a vector f are encoded and intensity-modulated using encoding information that varies on a wavelength band basis, and are then added to each other. Thus, H denotes a matrix having n×m rows and n×mx N columns. Eq. (1) can also be expressed as follows.

g=(pg₁₁ . . . pg₁ₘ . . . pgₙ₁ . . . . pgₙₘ)^{T}=H(f₁ . . . f_{N})^{T},

where pgᵢⱼ denotes the pixel value of the i-th row and j-th column of the compressed image 10.

When the vector g and the matrix H are given, it seems that the data f can be calculated by solving an inverse problem of Eq. (1). However, the number of elements (n×mx N) of the data f to be obtained is greater than the number of elements (n×m) of the acquired data g, and thus this problem is an ill-posed problem, and the problem cannot be solved as is. Thus, the processing apparatus 200 uses the redundancy of the images included in the data f and uses a compressed-sensing method to obtain a solution. Specifically, the data f to be obtained is estimated by solving the following Eq. (2).

$${f}^{′} = {arg min}_{f} \{ {‖ g - Hf ‖}_{{l}_{2}} + τΦ ( f ) \} \qquad ( 2 )$$

In this case, f′ denotes estimated data of the data f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term. Eq. (2) means to obtain f that minimizes the sum of the first term and the second term. The function in braces in Eq. (2) is called the evaluation function. The processing apparatus 200 can cause a solution to converge through a recursive iterative operation and can calculate, as the final solution f′, the f that minimizes the evaluation function.

The first term in the braces of Eq. (2) refers to a calculation for obtaining the sum of squares of the differences between the acquired data g and Hf, which is obtained by converting f in the estimation process using the matrix H. The second term Φ(f) is a constraint for regularization of f and is a function that reflects sparse information regarding estimated data. This function provides an effect in that estimated data is smoothed or stabilized. The regularization term can be expressed using, for example, discrete cosine transformation (DCT), wavelet transform, Fourier transform, or total variation (TV) of f. For example, in a case where total variation is used, stabilized estimated data can be acquired in which the effects of noise of the data g, observation data, are suppressed. The sparsity of the target 70 in each space of the regularization term differs with the texture of the target 70. A regularization term having regularization space in which the texture of the target 70 becomes sparser may be selected. Alternatively, regularization terms may be included in calculation. τ is a weighting factor. The greater the weighting factor t, the greater the amount of reduction of redundant data, thereby increasing a compression rate. The smaller the weighting factor τ, the lower the convergence to the solution. The weighting factor τ is set to an appropriate value with which f is converged to a certain degree and is not compressed too much.

Note that, in the configurations illustrated in FIGS. 12B and 12C, images encoded by the filter array 110 are acquired in bokeh states on the imaging surface of the image sensor 160. Thus, the hyperspectral image 20 can be reconstructed by reflecting the bokeh information in the above-described matrix H, the bokeh information being stored in advance. In this case, the bokeh information is expressed by a point spread function (PSF). The PSF is a function that defines the degree of spread of a point image to surrounding pixels. For example, in a case where a point image corresponding to one pixel on an image is spread to a region of k×k pixels around the pixel as a result of bokeh, the PSF can be defined as a group of factors, that is, a matrix indicating the effect on the pixel value of each pixel in the region. The effect of bokeh of an encoding pattern by the PSF is reflected in the matrix H, so that the hyperspectral image 20 can be reconstructed. The filter array 110 may be arranged at any position; however, a position may be selected where the encoding pattern of the filter array 110 does not spread so much as to disappear.

The above-described processing allows reconstruction of the hyperspectral image 20 from the compressed image 10 acquired by the image sensor 160.

In the above-described example, the processing apparatus 200 reconstructs the hyperspectral image 20 on the basis of the data of the compressed image 10 output from the image sensor 160. Instead of the processing apparatus 200, the processor in the imaging apparatus 100 may perform processing for reconstructing a hyperspectral image 20. In that case, a processor corresponding to the second processing circuit 214 in the processing apparatus 200 illustrated in FIG. 8 is built in the imaging apparatus 100. The processor generates data of the hyperspectral image 20 on the basis of data of the compressed image 10 output from the image sensor 160. Moreover, the processor corresponding to the second processing circuit 214 illustrated in FIG. 8 may be mounted in an external computer, such as a cloud server, that communicates with the imaging apparatus 100 or the processing apparatus 200 via a network. In that case, the external computer generates the data of the hyperspectral image 20 on the basis of the data of the compressed image 10 acquired from the imaging apparatus 100, and transmits the data of the hyperspectral image 20 to the processing apparatus 200.

### Another Example of Configuration of Imaging Apparatus

Next, another example of the configuration of the imaging apparatus 100 will be described.

A compressed image and a reconstructed image may be generated through imaging using a method different from imaging using an encoding element, namely the filter array 110 including the above-described optical filters.

For example, as the configuration of the imaging apparatus 100, the light-receiving characteristics of the image sensor 160 may be changed for each pixel by performing processing on the image sensor 160. Even through imaging using the image sensor 160 to which the processing has been performed, a compressed image can be generated similarly to as in the above-described example. That is, a compressed image may be generated by an imaging apparatus having a configuration in which the filter array 110 is built in the image sensor 160. In this case, encoding information corresponds to the light-receiving characteristics of the image sensor 160.

A configuration may also be used in which the optical characteristics of the optical system 140 are spatially and spectrally changed by introducing an optical element such as a metalens into at least part of the optical system 140 to compress the spectral information. A compressed image can also be generated by an imaging apparatus including the configuration. In this case, the encoding information is information corresponding to the optical characteristics of the optical element such as a metalens. In this manner, the imaging apparatus 100 having a configuration different from the configuration using the filter array 110 may be used to modulate the intensity of incident light for each wavelength to generate a compressed image and a reconstructed image.

In other words, the present disclosure also includes a configuration for generating a reconstructed image that includes more signals (for example, pixels) than the number of signals that the compressed image includes, on the basis of encoding information corresponding to the optical response characteristics of an imaging apparatus that includes light-receiving regions whose optical response characteristics differ from each other and a compressed image generated by the imaging apparatus 100. As described above, the optical response characteristics may correspond to the light receiving characteristics of the image sensor or may also correspond to the light-receiving characteristics of the optical element.

### APPENDIX 1

The present disclosure is not limited to the above-described embodiments. Examples obtained by adding various changes conceived by one skilled in the art to each embodiment, examples obtained by adding various changes conceived by one skilled in the art to each modification, forms constructed by combining constituent elements of different embodiments, forms constructed by combining constituent elements of different modifications, and forms constructed by combining constituent elements of any embodiment and constituent elements of any modification are also included in the scope of the present disclosure as long as these examples and forms do not depart from the gist of the present disclosure.

### APPENDIX 2

A modification of the embodiments of the present disclosure may be as follows.
(a) A method performed by one or more processors that execute instructions recorded in one or more memories,
the method including:
causing a light source to emit first light under a first emission condition,
causing an imaging apparatus to capture an image of a subject irradiated with the first light and as a result causing the imaging apparatus to generate four or more first data sets each including pixel values, and
in a case where the four or more first data sets do not satisfy a first predetermined condition, causing the light source to emit second light under a second emission condition, causing the imaging apparatus to capture an image of the subject irradiated with the second light, and as a result causing the imaging apparatus to generate four or more second data sets each including pixel values, and
a first value indicating the magnitude of a change in spectral shape determined on the basis of the four or more first data sets and the four or more second data sets is smaller than a threshold,
the four or more first data sets correspond to four or more wavelength ranges, and
the four or more second data sets correspond to the four or more wavelength ranges.
(b) The method may include not causing the light source to emit the second light under the second emission condition in a case where the four or more first data sets satisfy the first predetermined condition.
(c) In a case where each of the four or more first data sets includes n×m pixel values,
each of the four or more second data sets includes n×m pixel values,
the number of first data sets and that of second data sets are N,
the four or more first data sets are denoted by f₁₁, . . . , f_{1N}, and
the four or more second data sets are denoted by f₂₁, . . . , f_{2N},

$${f}_{11} = {( p {11}_{11} … p {11}_{1 m} … p 1 {1}_{n 1} … p {11}_{nm} )}^{T} ,$$

$${f}_{12} = {( p {12}_{11} … p {12}_{1 m} … p 1 {2}_{n 1} … p {12}_{nm} )}^{T} ,$$

$$… ,$$

$${f}_{1 N} = {( p 1 {N}_{11} … p 1 {N}_{1 m} … p 1 {N}_{n 1} … p 1 {N}_{nm} )}^{T} ,$$

$${f}_{21} = {( p {21}_{11} … p {21}_{1 m} … p {21}_{n 1} … p {21}_{nm} )}^{T} ,$$

$${f}_{22} = {( p {22}_{11} … p {22}_{1 m} … p {22}_{n 1} … p {22}_{nm} )}^{T} ,$$

$$… ,$$

$${f}_{2 N} = {( p 2 {N}_{11} … p 2 {N}_{1 m} … p 2 {N}_{n 1} … p 2 {N}_{nm} )}^{T} ,$$

where p11₁₁, . . . , p2Nₙₘ are each a pixel value, and
the first value may be determined on the basis of the absolute value of the angle formed by (p11₁₁ p12₁₁ . . . p1N₁₁) and (p21₁₁ p22₁₁ . . . p2N₁₁), . . . , the absolute value of the angle formed by (p11ₙₘ p12ₙₘ . . . p1Nₙₘ) and (p21ₙₘ p22ₙₘ . . . p2Nₙₘ).
(d) The first value may also be {(the absolute value of the angle₁₁)+ . . . + (the absolute value of the angleₙₘ)}/(n×m).
(e) The imaging apparatus may include four or more image sensors I₁, . . . , I_{N} corresponding to the four or more wavelength ranges,
the four or more image sensors I₁, . . . , I_{N} may correspond to the four or more first data sets f₁₁, . . . , f_{1N}, respectively,
the four or more image sensors I₁, . . . , I_{N} may correspond to the four or more second data sets f₂₁, . . . , f_{2N}, respectively,
the image sensor I₁ may include a pixel s1₁₁, . . . , a pixel s1₁ₘ, . . . , a pixel s1ₙ₁, . . . , a pixel s1ₙₘ, . . . ,
the image sensor I_{N} may include a pixel sN₁₁, . . . , a pixel sN₁ₘ, . . . , a pixel sNₙ₁, . . . , a pixel sNₙₘ,
the pixel s1₁₁ may correspond to the pixel value p11₁₁ and the pixel value p21₁₁, . . . ,
the pixel slim may correspond to the pixel value p11₁ₘ and the pixel value p21₁ₘ, . . . ,
the pixel s1ₙ₁ may correspond to the pixel value p11ₙ₁ and the pixel value p21ₙ₁, . . . ,
the pixel s1ₙₘ may correspond to the pixel value p11ₙₘ and the pixel value p21ₙₘ, . . . ,
the pixel sN₁₁ may correspond to the pixel value p1N₁₁ and the pixel value p2N₁₁, . . . ,
the pixel sN₁ₘ may correspond to the pixel value p1N₁ₘ and the pixel value p2N₁ₘ, . . . ,
the pixel sNₙ₁ may correspond to the pixel value p1Nₙ₁ and the pixel value p2Nₙ₁, . . . , and
the pixel sNₙₘ may correspond to the pixel value p1Nₙₘ and the pixel value p2Nₙₘ.

### APPENDIX 3

A modification of the embodiments of the present disclosure may be as follows.
(a) A method performed by one or more processors that execute instructions recorded in one or more memories,
the method including:
causing a light source to emit first light under a first emission condition,
causing an imaging apparatus including a filter array to capture an image of a subject irradiated with the first light, and as a result causing the imaging apparatus to generate first data including pixel values, the filter array including four or more filters, four or more luminous transmittance characteristics corresponding to the four or more respective filters being different from each other, the four or more luminous transmittance characteristics being luminous transmittances for a target wavelength range including four or more wavelength ranges, and
in a case where the first data does not satisfy a first predetermined condition, causing the light source to emit second light under a second emission condition, causing the imaging apparatus to capture an image of the subject irradiated with the second light, and as a result causing the imaging apparatus to generate second data including pixel values, and
a first value indicating the magnitude of a change in spectral shape determined on the basis of four or more first data sets generated on the basis of the first data and four or more second data sets generated on the basis of the second data is smaller than a threshold,
the four or more first data sets correspond to the four or more wavelength ranges, and
the four or more second data sets correspond to the four or more wavelength ranges.
(b) The method may include not causing the light source to emit the second light under the second emission condition in a case where the first data satisfies the first predetermined condition.
(c) In a case where each of the four or more first data sets includes n×m pixel values,
each of the four or more second data sets includes n×m pixel values,
the number of first data sets and the number of second data sets are N,
the four or more first data sets are denoted by f₁₁, . . . , f_{1N},
the four or more second data sets are denoted by f₂₁, . . . , f_{2N},
the first data is denoted by g₁, and
the second data is denoted by g₂,

$${f}_{11} = {( p {11}_{11} … p {11}_{1 m} … p 1 {1}_{n 1} … p {11}_{nm} )}^{T} ,$$

$${f}_{12} = {( p {12}_{11} … p {12}_{1 m} … p 1 {2}_{n 1} … p {12}_{nm} )}^{T} , … ,$$

$${f}_{1 N} = {( p 1 {N}_{11} … p 1 {N}_{1 m} … p 1 {N}_{n 1} … p 1 {N}_{nm} )}^{T} ,$$

$${f}_{21} = {( p {21}_{11} … p {21}_{1 m} … p {21}_{n 1} … p {21}_{nm} )}^{T} ,$$

$${f}_{22} = {( p {22}_{11} … p {22}_{1 m} … p {22}_{n 1} … p {22}_{nm} )}^{T} , … ,$$

$${f}_{2 N} = {( p 2 {N}_{11} … p 2 {N}_{1 m} … p 2 {N}_{n 1} … p 2 {N}_{nm} )}^{T} ,$$

pg1₁₁, . . . , pg1₁ₘ, . . . , pg1ₙ₁, . . . , pg1ₙₘ, pg2₁₁, . . . , pg2₁ₘ, . . . , pg2ₙ₁, . . . , pg2ₙₘ are each a pixel value,
the H is a matrix having n×m rows and n×m×N columns,

$${g}_{1} = {( pg {1}_{11} … pg {1}_{1 m} … pg {1}_{n 1} … pg {1}_{nm} )}^{T} = {H ( {f}_{11} … {f}_{1 N} )}^{T} ,$$

$${g}_{2} = {( pg {2}_{11} … pg {2}_{1 m} … pg {2}_{n 1} … pg {2}_{nm} )}^{T} = {H ( {f}_{21} … {f}_{2 N} )}^{T} ,$$

where p11₁₁, . . . , p2Nₙₘ are each a pixel value, and
the first value may be determined on the basis of the absolute value of an angle₁₁ formed by (p11₁₁ p12₁₁ . . . p1N₁₁) and (p21₁₁ p22₁₁ . . . p2N₁₁), . . . , and the absolute value of an angleₙₘ formed by (p11ₙₘ p12ₙₘ . . . p1Nₙₘ) and (p21ₙₘ p22ₙₘ . . . p2Nₙₘ).
(d) The first value may also be {(the absolute value of the angle₁₁)+ . . . + (the absolute value of the angleₙₘ)}/(n×m).
(e) The imaging apparatus may include an image sensor, the image sensor may include n×m pixels p₁₁ . . . . p₁ₘ . . . pₙ₁ . . . . pₙₘ, and
the pixel p₁₁ may correspond to the pixel value pg1₁₁ and the pixel value pg2₁₁, . . . , the pixel p₁ₘ may correspond to the pixel value pg1₁ₘ and the pixel value pg21₁ₘ, . . . , the pixel pₙ₁ may correspond to the pixel value pg1ₙ₁ and the pixel value pg2ₙ₁, . . . , and the pixel pₙₘ may correspond to the pixel value pg1ₙₘ and the pixel value pg2ₙₘ.

### APPENDIX 4

Based on description of the above-described embodiments, the following techniques are disclosed.

### Technique 1

An imaging system including:

a light source,

an imaging apparatus that captures an image of a subject illuminated by light from the light source to generate image data, which includes image information regarding each of four or more bands or information regarding a compressed image in which the image information regarding the four or more bands is compressed as a single image, and

a processing apparatus, and

the processing apparatus

determines whether or not pixel values of pixels in the image data satisfy a predetermined condition, and

causes, in a case where the predetermined condition is not satisfied, a lighting condition caused by the light source to be changed under a condition where a spectral shape of light from the light source does not change at the subject's location.

### Technique 2

The imaging system according to Technique 1, further including:

an adjustment apparatus that adjusts a distance between the light source and the subject, and

in a case where the predetermined condition is not satisfied, the processing apparatus causes the lighting condition to be changed by causing the adjustment apparatus to change the distance between the light source and the subject within a specified range.

### Technique 3

The imaging system according to Technique 2, in which in a case where the predetermined condition is not satisfied, the processing apparatus causes the adjustment apparatus to repeat an operation for changing the distance between the light source and the subject within the specified range until the condition becomes satisfied.

### Technique 4

The imaging system according to Technique 2 or 3, in which the adjustment apparatus changes the distance between the light source and the subject without changing an orientation of the light source.

### Technique 5

The imaging system according to Technique 1, in which in a case where the predetermined condition is not satisfied, the processing apparatus causes the lighting condition to be changed by causing a control parameter for driving the light source to be changed within a predetermined range.

### Technique 6

The imaging system according to any one of Techniques 1 to 5, in which determining whether or not the pixel values of the pixels satisfy the predetermined condition includes determining whether or not the pixel value of each of the pixels is within a predetermined range.

### Technique 7

The imaging system according to any one of Techniques 1 to 5, in which determining whether or not the pixel values of the pixels satisfy the predetermined condition includes determining whether or not a contrast value calculated from the pixel values of the pixels exceeds a threshold.

### Technique 8

The imaging system according to any one of Techniques 1 to 7, in which

the image data includes information regarding the compressed image, and the processing apparatus performs, in a case where the predetermined condition is satisfied, processing for generating an image of each of the four or more bands, based on the compressed image.

### Technique 9

The imaging system according to Technique 8, in which

the imaging apparatus includes
an optical element that changes a spatial distribution of intensity of light from the subject by wavelength, and
an image sensor that receives light having passed through the optical element to generate the image data including information regarding the compressed image.

### Technique 10

The imaging system according to any one of Techniques 1 to 5, in which the image data includes image information regarding each of the four or more bands.

### Technique 11

The imaging system according to any one of Techniques 1 to 5, in which

the imaging apparatus includes
an optical element that changes a spatial distribution of intensity of light from the subject by wavelength, and
an image sensor that receives light having passed through the optical element to output the image data including information regarding the compressed image,
wherein the processing apparatus generates, based on the image data output from the image sensor, other image data including image information regarding each of the four or more bands.

### Technique 12

The imaging system according to Technique 10 or 11, in which determining whether or not the pixel values of the pixels satisfy the predetermined condition includes determining whether or not the pixel value of each of pixels in each image for the four or more bands is within a predetermined range.

### Technique 13

The imaging system according to Technique 10 or 11, in which determining whether or not the pixel values of the pixels satisfy the predetermined condition includes determining whether or not a contrast value calculated from the pixel values of the pixels in each image for the four or more bands exceeds a threshold.

### Technique 14

The imaging system according to Technique 9 or 11, in which the optical element includes optical filters arranged in a two-dimensional plane, spectral transmittances of the optical filters are different from each other, and the spectral transmittances of the respective optical filters exhibit local maxima.

### Technique 15

The imaging system according to any one of Techniques 1 to 14, further including:

a storage device that stores data indicating a specified range for a parameter that defines the lighting condition, and

the processing apparatus changes the lighting condition by changing, based on the data, the parameter within the specified range.

### Technique 16

The imaging system according to any one of Techniques 2 to 4, further including:

a stage that has a support surface for supporting the subject, and

the adjustment apparatus includes a linear actuator that changes the distance between the light source and the subject by moving the light source in a direction perpendicular to the support surface of the stage.

### Technique 17

The imaging system according to any one of Techniques 1 to 16, in which

the processing apparatus determines, based on a relationship between calibration image data generated by the imaging apparatus capturing an image of a calibration subject illuminated by light from the light source and a parameter that defines the lighting condition, a specified range for the parameter in which the spectral shape at the subject's location does not change, and

changes the parameter within the specified range to change the lighting condition.

### Technique 18

The imaging system according to Technique 17, in which

the processing apparatus

causes the imaging apparatus to generate the calibration image data while changing the parameter, and

determines a range of the parameter in which a change amount in the spectral shape of the calibration subject identified based on the calibration image data is smaller than a predetermined amount to be the specified range.

### Technique 19

The imaging system according to any one of Techniques 1 to 18, in which before image capturing of the subject is performed, the processing apparatus

acquires calibration image data generated by the imaging apparatus capturing an image of a calibration subject illuminated by light from the light source,

determines whether or not pixel values of pixels in the calibration image data satisfy the predetermined condition,

in a case where the predetermined condition is satisfied, generates spectral data of the calibration subject based on the calibration image data and causes a storage device to store the spectral data, and

in a case where the predetermined condition is not satisfied, changes a parameter that defines the lighting condition within a specified range.

### Technique 20

A method performed by one or more processors that execute instructions recorded in one or more memories, the method including:

acquiring image data from an imaging apparatus that captures an image of a subject illuminated by light from a light source to generate image data, the image data including image information regarding each of four or more bands or information regarding a compressed image in which the image information regarding the four or more bands is compressed as a single image,

determining whether or not pixel values of pixels in the image data satisfy a predetermined condition, and

causing, in a case where the predetermined condition is not satisfied, a lighting condition caused by the light source to be changed under a condition where a spectral shape of light from the light source does not change at the subject's location.

The techniques of the present disclosure are widely applicable to cameras and measurement devices that acquire images at multiple wavelengths, such as hyperspectral cameras, for example. The techniques of the present disclosure can be applied, for example, to applications such as line inspection in factories, where quality is evaluated by identifying slight color changes.

What is claimed is:

1. An imaging system comprising:
a light source;
an imaging apparatus that captures an image of a subject illuminated by light from the light source to generate image data, which includes image information regarding each of four or more bands or information regarding a compressed image in which the image information regarding the four or more bands is compressed as a single image; and
a processing apparatus, wherein
the processing apparatus
determines whether or not pixel values of pixels in the image data satisfy a predetermined condition, and
causes, in a case where the predetermined condition is not satisfied, a lighting condition caused by the light source to be changed under a condition where a spectral shape of light from the light source does not change at the subject's location.

2. The imaging system according to claim 1, further comprising:
an adjustment apparatus that adjusts a distance between the light source and the subject,
wherein in a case where the predetermined condition is not satisfied, the processing apparatus causes the lighting condition to be changed by causing the adjustment apparatus to change the distance between the light source and the subject within a specified range.

3. The imaging system according to claim 2, wherein in a case where the predetermined condition is not satisfied, the processing apparatus causes the adjustment apparatus to repeat an operation for changing the distance between the light source and the subject within the specified range until the condition becomes satisfied.

4. The imaging system according to claim 2, wherein
the adjustment apparatus changes the distance between the light source and the subject without changing an orientation of the light source.

5. The imaging system according to claim 1, wherein in a case where the predetermined condition is not satisfied, the processing apparatus causes the lighting condition to be changed by causing a control parameter for driving the light source to be changed within a predetermined range.

6. The imaging system according to claim 1, wherein determining whether or not the pixel values of the pixels satisfy the predetermined condition includes determining whether or not the pixel value of each of the pixels is within a predetermined range.

7. The imaging system according to claim 1, wherein determining whether or not the pixel values of the pixels satisfy the predetermined condition includes determining whether or not a contrast value calculated from the pixel values of the pixels exceeds a threshold.

8. The imaging system according to claim 1, wherein
the image data includes information regarding the compressed image, and
the processing apparatus performs, in a case where the predetermined condition is satisfied, processing for generating an image of each of the four or more bands, based on the compressed image.

9. The imaging system according to claim 8, wherein
the imaging apparatus includes
an optical element that changes a spatial distribution of intensity of light from the subject by wavelength, and
an image sensor that receives light having passed through the optical element to generate the image data including information regarding the compressed image.

10. The imaging system according to claim 1, wherein the image data includes image information regarding each of the four or more bands.

11. The imaging system according to claim 1, wherein
the imaging apparatus includes
an optical element that changes a spatial distribution of intensity of light from the subject by wavelength, and
an image sensor that receives light having passed through the optical element to output the image data including information regarding the compressed image,
wherein the processing apparatus generates, based on the image data output from the image sensor, other image data including image information regarding each of the four or more bands.

12. The imaging system according to claim 10, wherein determining whether or not the pixel values of the pixels satisfy the predetermined condition includes determining whether or not the pixel value of each of pixels in each image for the four or more bands is within a predetermined range.

13. The imaging system according to claim 10, wherein determining whether or not the pixel values of the pixels satisfy the predetermined condition includes determining whether or not a contrast value calculated from the pixel values of the pixels in each image for the four or more bands exceeds a threshold.

14. The imaging system according to claim 11, wherein the optical element includes optical filters arranged in a two-dimensional plane, spectral transmittances of the optical filters are different from each other, and the spectral transmittances of the respective optical filters exhibit local maxima.

15. The imaging system according to claim 1, further comprising:
a storage device that stores data indicating a specified range for a parameter that defines the lighting condition, wherein
the processing apparatus changes the lighting condition by changing, based on the data, the parameter within the specified range.

16. The imaging system according to claim 2, further comprising:
a stage that has a support surface for supporting the subject, wherein
the adjustment apparatus includes a linear actuator that changes the distance between the light source and the subject by moving the light source in a direction perpendicular to the support surface of the stage.

17. The imaging system according to claim 1, wherein
the processing apparatus determines, based on a relationship between calibration image data generated by the imaging apparatus capturing an image of a calibration subject illuminated by light from the light source and a parameter that defines the lighting condition, a specified range for the parameter in which the spectral shape at the subject's location does not change, and
changes the parameter within the specified range to change the lighting condition.

18. The imaging system according to claim 17, wherein
the processing apparatus
causes the imaging apparatus to generate the calibration image data while changing the parameter, and
determines a range of the parameter in which a change amount in the spectral shape of the calibration subject identified based on the calibration image data is smaller than a predetermined amount to be the specified range.

19. The imaging system according to claim 1, wherein before image capturing of the subject is performed, the processing apparatus
acquires calibration image data generated by the imaging apparatus capturing an image of a calibration subject illuminated by light from the light source,
determines whether or not pixel values of pixels in the calibration image data satisfy the predetermined condition,
in a case where the predetermined condition is satisfied, generates spectral data of the calibration subject based on the calibration image data and causes a storage device to store the spectral data, and
in a case where the predetermined condition is not satisfied, changes a parameter that defines the lighting condition within a specified range.

20. A method performed by one or more processors that execute instructions recorded in one or more memories, the method comprising:
acquiring image data from an imaging apparatus that captures an image of a subject illuminated by light from a light source to generate image data, the image data including image information regarding each of four or more bands or information regarding a compressed image in which the image information regarding the four or more bands is compressed as a single image;
determining whether or not pixel values of pixels in the image data satisfy a predetermined condition; and
causing, in a case where the predetermined condition is not satisfied, a lighting condition caused by the light source to be changed under a condition where a spectral shape of light from the light source does not change at the subject's location.
